(19) United States
(12) Patent Application Publication
(10) Pub. No.: US 2005/0034547 A1
(43) Pub. Date: Feb. 17, 2005

(54) Mechanisms based on torque equalization principles

(76) Inventors: Harry C. Sweere, Minneapolis, MN (US); Mustafa A. Ergun, Shoreview, MN (US); Shaun C. Lindblad, Lino Lakes, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/903,316

(22) Filed: Jul. 30, 2004

Related U.S. Application Data
(63) Continuation-in-part of application No. 10/792,467, filed on Mar. 3, 2004.
(60) Provisional application No. 60/492,015, filed on Aug. 1, 2003.
(60) Provisional application No. 60/585,781, filed on Jul. 6, 2004.
(60) Provisional application No. 60/586,375, filed on Jul. 8, 2004.

(51) Int. Cl. F16H 37/00

(52) U.S. Cl. 74/1 R

(57) ABSTRACT

Methods and apparatus for providing an adjustable balancing force are provided. This mechanism can be used as a lifting force, a counter balancing mechanism or as a horizontal or other force mechanism. The force can be designed to be constant or variable over the range of motion by properly calculating the shape of the cam member. A balancing mechanism in accordance with the present invention includes a wheel comprising a pulley member and a cam member. A first cable connects the cam member of the wheel to a energy source for biasing the wheel to rotate in a first direction. A second cable is connected to the pulley member of the wheel for communicating a balancing or load force to the wheel. In some useful embodiments of the present invention, the cam member is shaped and positioned so that a torque applied to the wheel by the first cable is substantially constant while a force applied to the wheel by the first cable varies.

### RELATED APPLICATIONS

The present Application is a continuation in part of U.S. application Ser. No. 10/792,467, filed on Mar. 3, 2004.

The present Application claims the benefit of U.S. Provisional Patent Application No. 60/492,015, filed on Aug. 1, 2003.

The present Application claims the benefit of U.S. Provisional Patent Application No. 60/585781, filed Jul. 6, 2004.

The present Application claims the benefit of U.S. Provisional Patent Application No. 60/586375, filed Jul. 8, 2004.

The entire disclosure of the above-mentioned patent applications is hereby incorporated by reference herein.

### FIELD OF THE INVENTION

The present invention relates generally to an apparatus for supporting a load or for supplying a pre-determined force either constant or variable in either a vertical or horizontal or other orientation.

### BACKGROUND OF THE INVENTION

There are many applications in which lifts, counter-balances and force providing mechanisms may be useful. Mechanisms such as these can be used to raise and lower a variety of items including, but not limited to, the examples listed below:
video monitors of all sizes
furniture work surfaces
production assembly tools
work load transfer equipment
kitchen cabinets
vertically oriented exercise equipment
robot control devices
windows

These mechanisms can also be used to provide forces in other orientations (e.g., horizontal). Examples of such applications include, but are not limited to:
continuous constant force feeding systems for machine tools
horizontally oriented exercise equipment
drawer closing applications
door closing application

One application for such a mechanism is the support of a display monitor for a personal computer. Personal computers and/or display monitors are often placed directly on a desk or on a computer case. However, to increase desk space, or to respond to the ergonomic needs of different operators, computer monitors are sometimes mounted on elevating structures. Alternatively, monitors are mounted to a surface such as a wall, instead of placing the monitor on a desk or a cart.

However, personal computers and/or display monitors are often used by multiple operators at different times during a day. In some settings, one computer and/or monitor may be used by multiple people of different sizes and having different preferences in a single day. Given the differences in people's size and differences in their preferences, a monitor or display adjusted at one setting for one individual is highly likely to be inappropriate for another individual. For instance, a child would have different physical space needs than an adult using the same computer and monitor.

In addition, operators are using computers for longer periods of time which increases the importance of comfort to the operator. An operator may choose to use the monitor as left by the previous user despite the discomfort, annoyance and inconvenience experienced by a user who uses settings optimized for another individual, which may even result in injury after prolonged use.

Moreover, as monitors grow in size and weight, ease of adjustability is an important consideration. For monitors requiring frequent adjustment, adjustability for monitors has been provided using an arm coupled with gas springs, where the arm is hingedly coupled with the desk or a vertical surface. However, the gas springs are costly and wear out over time. In addition, the gas springs require a significant amount of space, for instance arm length, which can be at a premium in certain applications, such as in hospitals.

Thus, there is a need for a monitor support mechanism which is compact, less costly to manufacture and maintain, has increased reliability, allows easy adjustability, is scalable to many different sized monitors, is adaptable to provide a long range of travel, and is adaptable to provide constant support force as the monitor is being positioned.

### SUMMARY OF THE INVENTION

The present invention relates generally to an apparatus for supporting a load or for supplying a pre-determined force in either a vertical or a horizontal or other orientation. The attached drawings and detailed description depict selected exemplary embodiments and are not intended to limit the scope of the invention. In order to describe the details of the invention, reference is made to a video monitor lift application as one example of the many applications in which the inventive device can be used.

A machine in accordance with the present invention can be designed to produce a constant force over a range of travel or it can be designed to produce a pre-determined variable force over its range of travel. For example, in lifting a system utilizing cables, the machine can be programmed to vary its lift force as the system arises to compensate for the increasing weight of the cables.

An additional advantageous aspect of the present invention, is that it is scalable in that it can be designed to counterbalance/support a load over a broad range of applications and weights. For example from a few pounds to hundreds or thousands of pounds. One of the most innovative features of this machine is that it is easily adjustable to produce a range of forces with a given mechanism size (e.g. 6-16 pounds).

Another significant feature of a mechanism in accordance with the present invention is that it uses the absolutely lowest cost energy to lift a load when compared to existing lift technology which utilizes electrical motors, hydraulic motors, or gas springs as their power source. A coil spring suitable for use in the present invention may cost, for example, on the order of eighteen cents, whereas a gas spring suitable for use with a prior art lifting technology may cost about six dollars. By way of another example, a lift providing support for an 80 pound load through 20 inches of travel using only about four dollars worth of coil springs. In contrast, a prior art lifting technology, capable of supporting a 70 pound load across sixteen inches of travel, may require, for example, two gas springs costing twenty-two dollars each.

A balancing mechanism in accordance with one exemplary embodiment of the present invention includes a wheel comprising a pulley member and a cam member. A first cable connects the cam member of the wheel to an energy source for biasing the wheel to rotate in a first direction. The energy source may comprise, for example, extension springs, compression springs, torsion springs or any other source that provides a force output as a function of displacement/deflection. A second cable is connected to the pulley member of the wheel for communicating a balancing or load force to the wheel.

In some useful embodiments of the present invention, the cam member is shaped and positioned so that a torque applied to the wheel by the first cable is substantially constant while a force applied to the wheel by the first cable varies. In one exemplary embodiment, an apparatus in accordance with the present invention the balance mechanism provides a balancing force between an inner rail of a slide and an outer rail of the slide. In another exemplary embodiment, an apparatus in accordance with the present invention the balance mechanism provides a balancing force between a base and a trolley.

### DESCRIPTION OF THE DRAWINGS

FIG. 1 is an elevation view of an apparatus in accordance with an exemplary embodiment of the present invention.

FIG. 2 is an additional elevation view of apparatus shown in the previous figure.

FIG. 3 is a perspective view of apparatus shown in the previous figure.

FIG. 4 is an additional perspective view of apparatus shown in the previous figure.

FIG. 5 is a plan view of an apparatus in accordance with an additional exemplary embodiment of the present invention.

FIG. 6 is an elevation view of an apparatus in accordance with an exemplary embodiment of the present invention.

FIG. 7 is an additional elevation view of apparatus shown in the previous figure.

FIG. 8 is an additional elevation view of apparatus shown in the previous figure.

FIG. 9 is an additional elevation view of apparatus shown in the previous figure.

FIG. 10 is a front view of an apparatus in accordance with an additional exemplary embodiment of the present invention.

FIG. 11 is an additional front view of apparatus shown in the previous figure.

FIG. 12 is a perspective view of an apparatus in accordance with an exemplary embodiment of the present invention.

FIG. 13 is an exploded view of the apparatus shown in the previous figure.

FIG. 14 is a top view of a pivot mechanism in accordance with an additional exemplary embodiment of the present invention.

FIG. 15 is a side view of the pivot mechanism shown in the previous figure.

FIG. 16 is an additional side view of the pivot mechanism shown in the previous figure.

FIG. 17 is a top view of a pivot mechanism in accordance with an additional exemplary embodiment of the present invention.

FIG. 18 is a side view of the pivot mechanism shown in the previous figure.

FIG. 19 is an additional side view of the pivot mechanism shown in the previous figure.

FIG. 20 is an additional side view of the pivot mechanism shown in the previous figure.

FIG. 21 is a top view of a pivot mechanism in accordance with an additional exemplary embodiment of the present invention.

FIG. 22 is a side view of the pivot mechanism shown in the previous figure.

FIG. 23 is an additional side view of the pivot mechanism shown in the previous figure.

FIG. 24 is an elevation view of an apparatus in accordance with an additional exemplary embodiment of the present invention.

FIG. 25 is a bottom view of the apparatus shown in the previous figure.

FIG. 26 is a front view of an apparatus in accordance with an additional exemplary embodiment of the present invention.

FIG. 27 is an elevation view of an apparatus in accordance with an additional embodiment of the present invention.

### DETAILED DESCRIPTION

The following detailed description should be read with reference to the drawings, in which like elements in different drawings are numbered identically. The drawings, which are not necessarily to scale, depict selected embodiments and are not intended to limit the scope of the invention. Examples of constructions, materials, dimensions, and manufacturing processes are provided for selected elements. All other elements employ that which is known to those of skill in the field of the invention. Those skilled in the art will recognize that many of the examples provided have suitable alternatives that can be utilized.

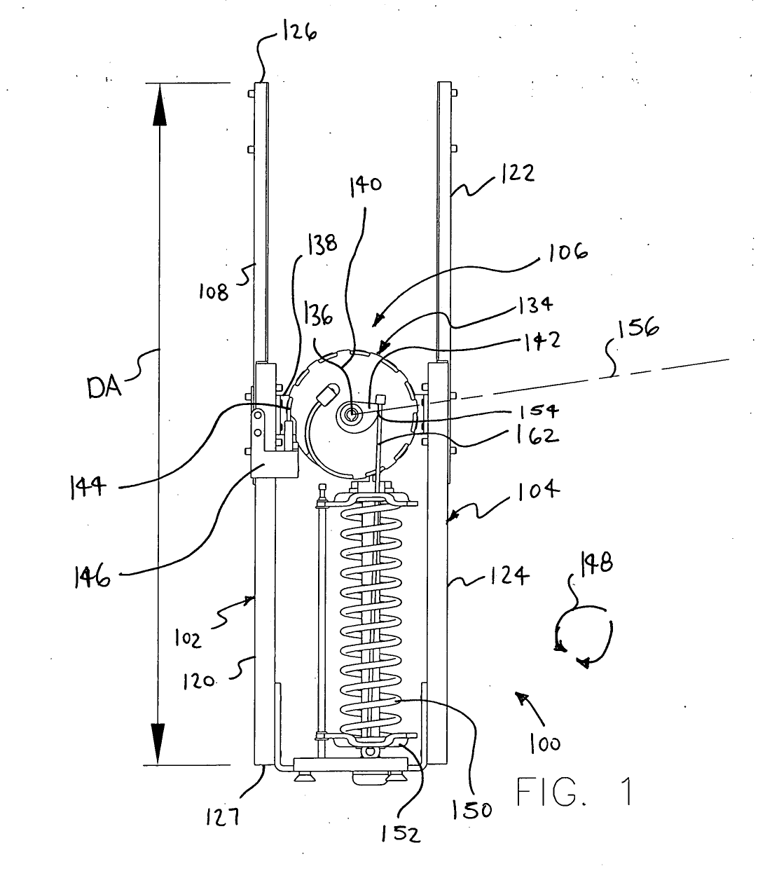

FIG. 1 is an elevation view of an apparatus 100 in accordance with an exemplary embodiment of the present invention. Apparatus 100 of FIG. 1 comprises a first slide 102, a second slide 104 and a balance mechanism 106. First slide 102 comprises a first inner rail 108 and a first outer rail 120 that are disposed in sliding engagement with one another. In the embodiment of FIG. 1, balance mechanism 106 provides a balancing force between first inner rail 108 and first outer rail 120.

Second slide 104 of apparatus 100 comprises a second inner rail 122 and a second outer rail 124 that are disposed in sliding engagement with one another. In the embodiment of FIG. 1, first slide 102 and second slide 104 are both disposed in a generally extended state. With reference to FIG. 1 it may be appreciated that, distal end 126 of first inner rail 108 is separated from distal end 127 of first outer rail 120 by a distance DA. A wheel 134 of balance mechanism 106 is pivotally supported by first outer rail 120 and second outer rail 124 with wheel 134 being free to rotate about a pivot axis 136. In the embodiment of FIG. 1, wheel 134 is coupled to first outer rail 120 and second outer rail 124 by a flange 138.

In the embodiment of FIG. 1, wheel 134 comprises a pulley member 140 and a cam member 142. Pulley member 140 of wheel 134 is coupled to first inner rail 108 of first slide 102 by a second cable 144 and a bracket 146. In the embodiment of FIG. 1, wheel 134 may be urged to rotate in a counter-clockwise direction 148 by moving distal end 126 of first inner rail 108 toward distal end 127 of first outer rail 120. In some embodiments of the present invention, however, wheel 134 is biased to rotate in a clockwise direction by a spring. This bias provides a balancing force between first inner rail 108 and first outer rail 120

In the embodiment of FIG. 1, cam member 142 of wheel 134 is coupled to a spring 150 by a first cable 162 and a bottom spring plate 152. In FIG. 1 first cable 162 is shown contacting cam member 142 at a first intersection 154. A first reference line 156 is shown passing through pivot axis 136 of wheel 134 and first intersection 154 in FIG. 1.

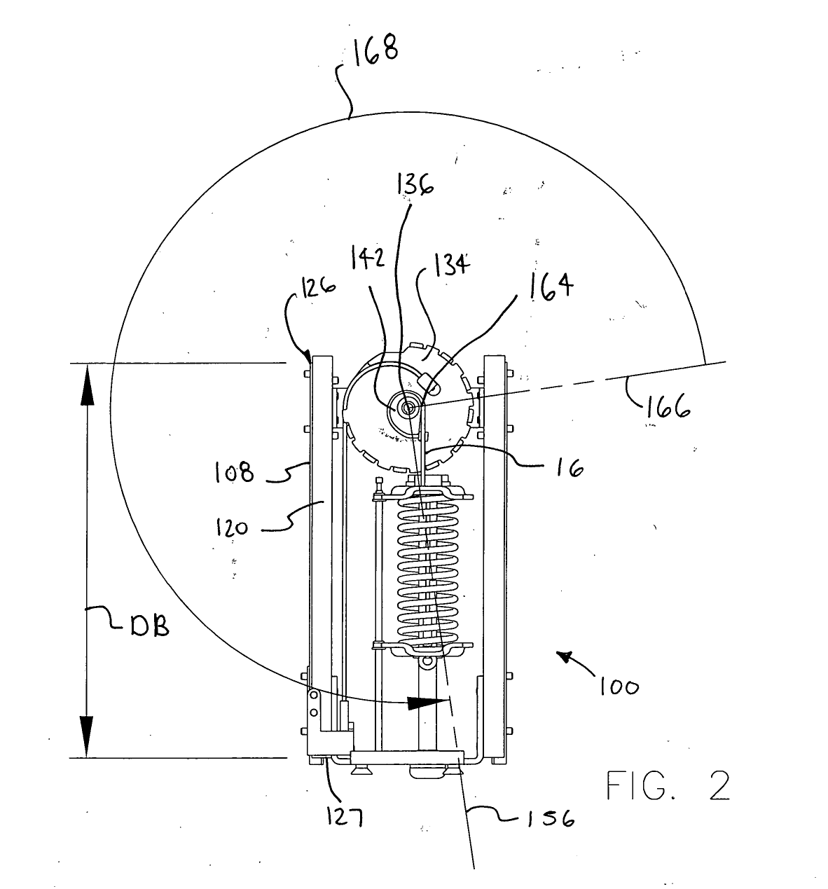

FIG. 2 is an additional elevation view of apparatus 100 shown in the previous figure. In the embodiment of FIG. 2, wheel 134 and first reference line 156 have been rotated in a counter-clockwise direction relative to the positions shown in the previous figure. With reference to the figures, it will be appreciated that first reference line 156 and wheel 134 have been rotated in unison (i.e., first reference line 156 has been rotated by the same angle that wheel 134 has been rotated).

In the embodiment of FIG. 2, apparatus 100 has assumed a generally retracted state in which distal end 126 of first inner rail 108 is located closer to distal end 127 of first outer rail 120 (relative to the state shown in the previous figure). In FIG. 2, the distance between distal end 126 of first inner slide 128 and distal end 127 of first outer rail 120 is labeled DB. With reference to FIG. 2, it will be appreciated that distance DB is smaller than the length of first inner rail 108. It will also be appreciated that distance DB is smaller than distance DA shown in the previous figure.

In FIG. 2, first cable 162 is shown contacting cam member 142 at a second intersection 164. A second reference line 166 is shown passing through pivot axis 136 of wheel 134 and second intersection 164 in FIG. 2. Second reference line 166 and first reference line 156 define an angle 168 in FIG. 2. In the embodiment of FIG. 2, angle 168 represents a rotational range of travel associated with wheel 134. With reference to the figures, it will be appreciated wheel 134 has a first angular orientation corresponding to an expanded configuration of apparatus 100. It will also be appreciated that wheel 134 has a second angular orientation corresponding to a contracted configuration of apparatus 100.

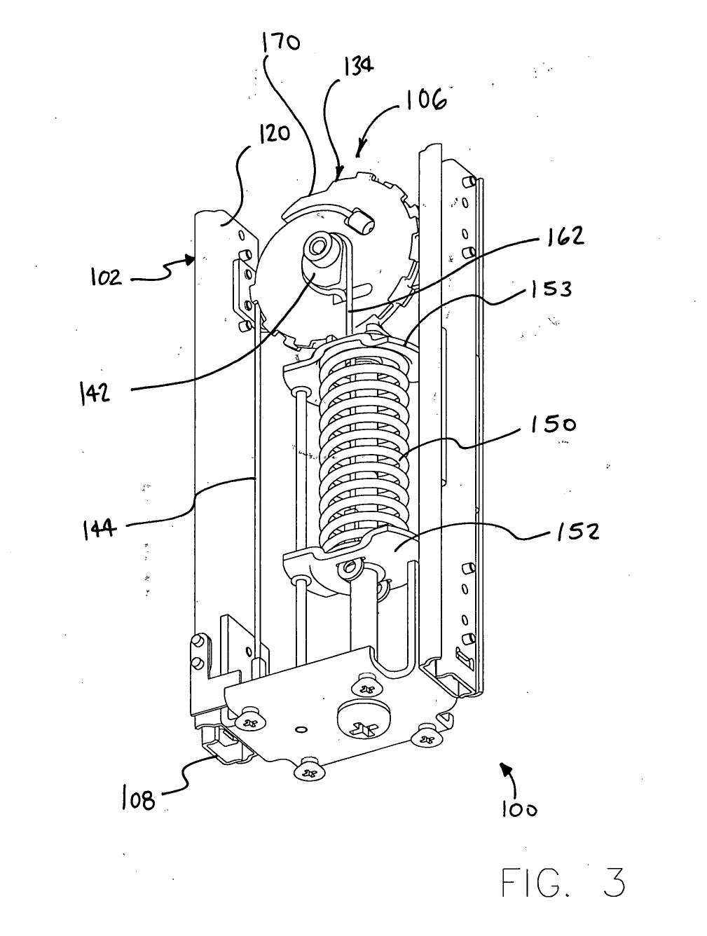

FIG. 3 is a perspective view of apparatus 100 shown in the previous figure. Apparatus 100 comprises a balance mechanism 106 that is capable of providing a balancing force between first inner rail 108 and first outer rail 120. In the embodiment of FIG. 3, first inner rail 108 is disposed in a generally retracted position with respect to first outer rail 120.

In the embodiment of FIG. 3, balance mechanism 106 comprises a wheel 134 and spring 150. Spring 150 is disposed between a bottom spring plate 152 and a top spring plate 153 in FIG. 3. In the embodiment of FIG. 3, spring 150 is capable of assuming a relaxed shape and a plurality of compressed shapes. For example, spring 150 may assume a completely relaxed shape when no forces act on spring 150 to hold it in compression. In the embodiment of FIG. 3, spring 150 is pictured having a somewhat compressed shape relative to its relaxed shape.

Spring 150 is coupled to a cam member 142 of wheel 134 by a first cable 162 so that spring 150 biases wheel 134 to rotate in a clockwise direction. A pulley portion 170 of wheel 134 is coupled to a first inner rail 108 of a first slide 102 by a second cable 144. A balancing force is applied between first inner rail 108 and first outer rail 120 by second cable 144 and wheel 134 of balance mechanism 106. In some useful embodiments of the present invention, cam member 142 is shaped and positioned so that a torque applied to wheel 134 by first cable 162 is substantially constant while a force applied to wheel 134 by first cable 162 varies. When this is the case, second cable 144 preferably applies a substantially constant balancing force to first inner rail 108.

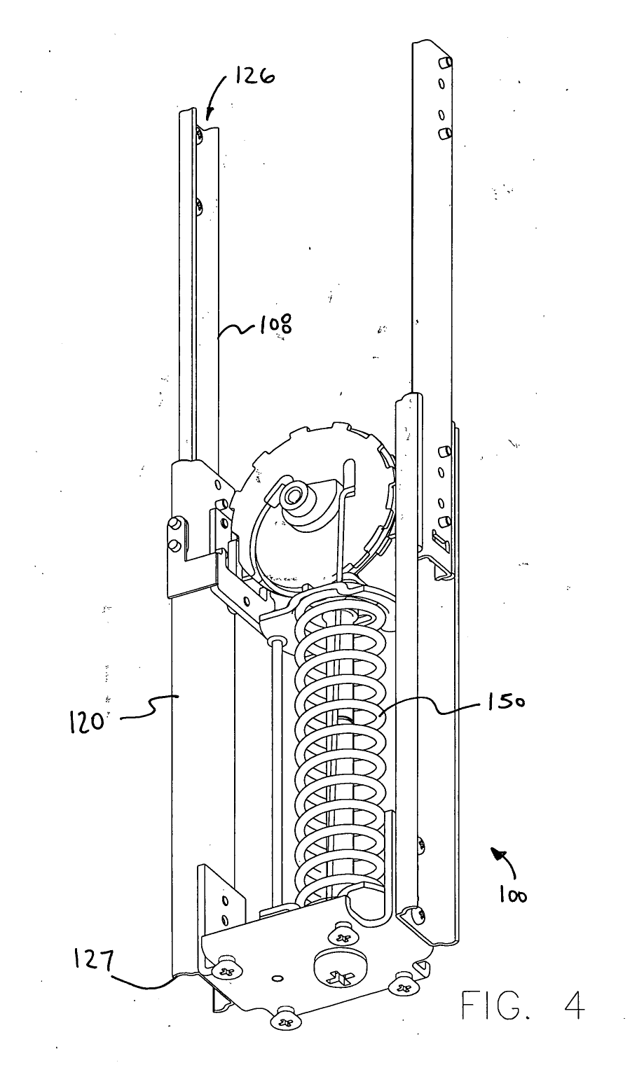

FIG. 4 is an additional perspective view of apparatus 100 shown in the previous figure. In FIG. 4, spring 150 is shown assuming a shape that is less compressed than the shape shown in the previous figure. In the embodiment of FIG. 4, first inner rail 108 is disposed in a generally extended position with respect to first outer rail 120. Accordingly, apparatus 100 is shown in a generally extended state in which distal end 126 of first inner rail 108 is located farther from distal end 127 of first outer rail 120 (relative to the state shown in the previous figure).

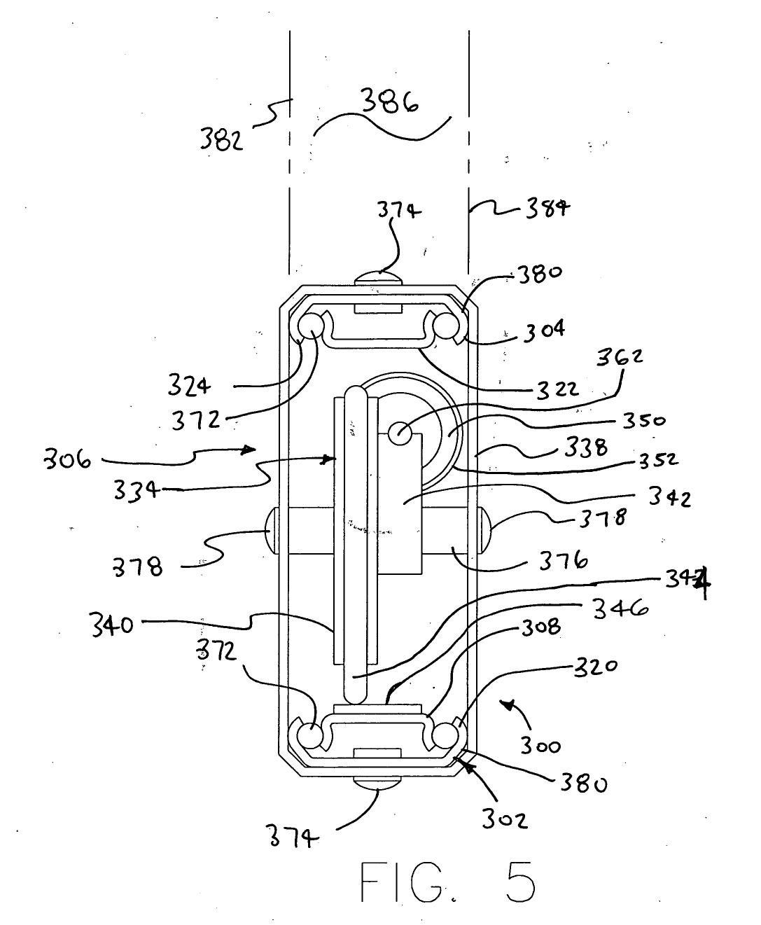

FIG. 5 is a plan view of an apparatus 300 in accordance with an additional exemplary embodiment of the present invention. Apparatus 300 of FIG. 5 comprises a first slide 302 including a first inner rail 308 and a first outer rail 320. With reference to FIG. 5, it may be appreciated that a plurality of balls 372 are disposed between first inner rail 308 and first outer rail 320. Apparatus 300 also comprises a second slide 304 including a second inner rail 322, a second outer rail 324 and a plurality of balls 372 disposed therebetween.

In FIG. 5, a flange 338 is shown disposed about first slide 302 and second slide 304. Flange 338 is fixed to first outer rail 320 of first slide 302 by a fastener 374. A second fastener 374 is shown fixing second outer rail 324 to flange 338. In the embodiment of FIG. 5, a shaft 376 is fixed to flange 338 by a plurality of fasteners 378. In the embodiment of FIG. 5, shaft 376 rotatably supports a wheel 334 of a balance mechanism 306.

In the embodiment of FIG. 5, balance mechanism 306 also comprises a spring 350. A cam member 342 of wheel 334 is coupled to spring 350 by a first cable 362 and a bottom spring plate 352. A pulley member 340 of wheel 334 is coupled to first inner rail 308 of first slide 302 by a second cable 344 and a bracket 346. Balance mechanism 306 may advantageously provide a balancing force between first inner rail 308 and first outer rail 320 in the embodiment of FIG. 5. In some useful embodiments of the present invention, cam member 342 is shaped and positioned so that a torque applied to wheel 334 by first cable 362 is substantially constant while a force applied to wheel 334 by first cable 362 varies. When this is the case, second cable 344 preferably applies a substantially constant balancing force to first inner rail 308.

With reference to FIG. 5, it will be appreciated that an outside surface 380 of first outer rail 320 and an outside surface 380 of second outer rail 324 define a first reference plane 382 and a second reference plane 384. In the embodiment of FIG. 5, balance mechanism 306 is disposed between first reference plane 382 and second reference plane 384. Also in the embodiment of FIG. 5, balance mechanism 306 is disposed within a projection 386 defined by outside surface 380 of first outer rail 320. In FIG. 5, projection 386 extends between first reference plane 382 and second reference plane 384.

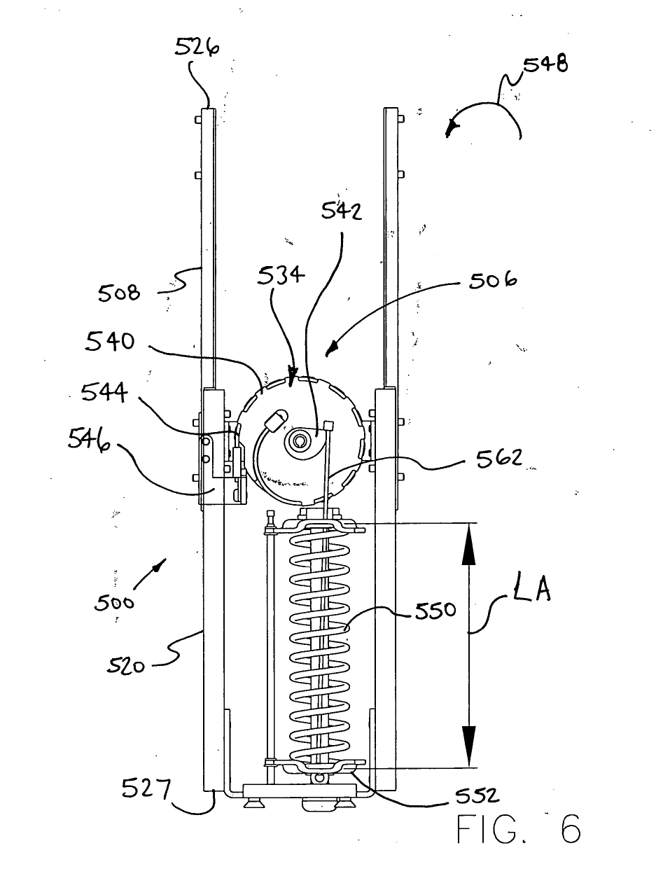

FIG. 6 is an elevation view of an apparatus 500 in accordance with an exemplary embodiment of the present invention. Apparatus 500 of FIG. 6 includes a balance mechanism 506 that is coupled between a first inner rail 508 and a first outer rail 520. Balance mechanism 506 may advantageously provide a balancing force between first inner rail 508 and first outer rail 520. In the embodiment of FIG. 6, balance mechanism 506 comprises a wheel 534 and a spring 550.

In the embodiment of FIG. 6, wheel 534 comprises a cam member 542 that is coupled to spring 550 by a first cable 562 and a bottom spring plate 552. In some useful embodiments of the present invention, cam member 542 is shaped and positioned so that a torque applied to wheel 534 by spring 550 is substantially constant while a force applied to wheel 534 by spring 550 varies. The force provided by spring 550 may vary, for example, as the deflection of spring 550 varies.

In the embodiment of FIG. 6, spring 550 is capable of assuming a relaxed shape and a plurality of compressed shapes. For example, spring 550 may assume a completely relaxed shape when no forces act on spring 550 to hold it in compression. In the embodiment of FIG. 6, spring 550 is pictured having a somewhat compressed shape relative to its relaxed shape. When spring 550 assumes the shape shown in FIG. 6, spring 550 has a length LA.

In the embodiment of FIG. 6, wheel 534 comprises a pulley member 540 that is coupled to first inner rail 508 of first slide 502 by a bracket 546 and a second cable 544. Accordingly, wheel 534 may be urged to rotate in a counter-clockwise direction 548 by moving distal end 526 of first inner rail 508 toward distal end 527 of first outer rail 520. In some useful embodiments of the present invention, second cable 544 applies a substantially constant balancing force to first inner rail 508.

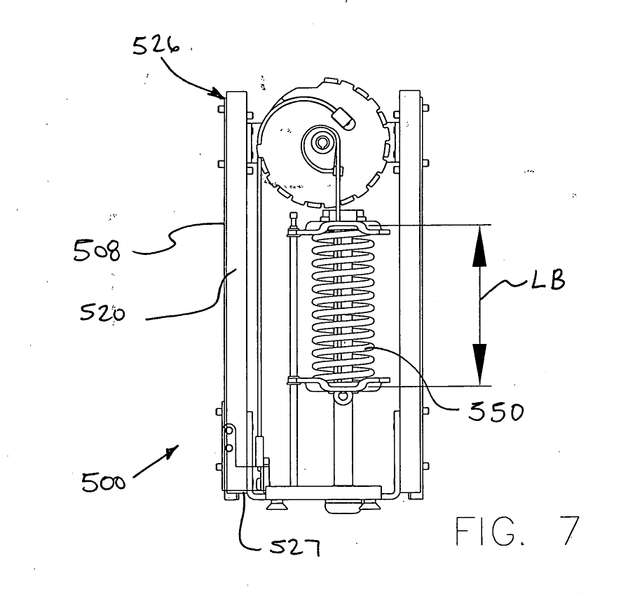

FIG. 7 is an additional elevation view of apparatus 500 shown in the previous figure. In the embodiment of FIG. 7, apparatus 500 is shown in a generally retracted state in which distal end 526 of first inner rail 508 is located closer to distal end 527 of first outer rail 520 (relative to the state shown in the previous figure). An over-all length of spring 550 is labeled LB in FIG. 7. In FIG. 7, spring 550 is shown assuming a shape that is more compressed than the shape shown in the previous figure. Accordingly, length LB shown in FIG. 7 is generally smaller than length LA shown in the previous figure.

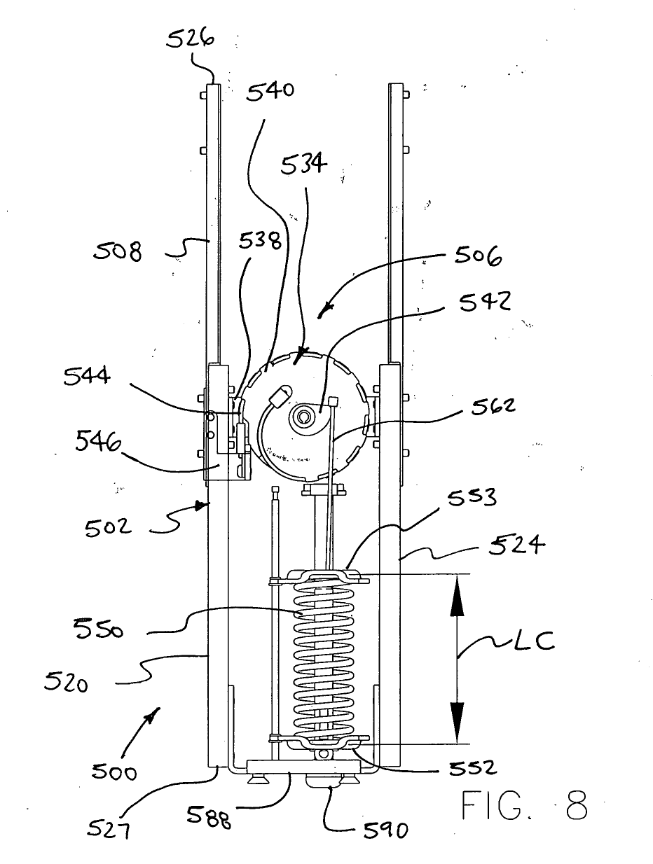

FIG. 8 is an additional elevation view of apparatus 500 shown in the previous figure. Apparatus 500 of FIG. 8 includes a balance mechanism 506 comprising a spring 550 that is disposed between a bottom spring plate 552 and a top spring plate 553. Top spring plate 553 is coupled to a base 588 of apparatus 500 by an adjustment screw 590. The distance between top spring plate 553 and base 588 can be adjusted by rotating adjustment screw 590.

In the embodiment of FIG. 8, top spring plate 553 has been positioned so that spring 550 has assumed a length LC. With reference to the figures, it will be appreciated that length LC is generally smaller than length LA shown in FIG. 6. In the embodiment of FIG. 8, spring 550 is capable of assuming a relaxed shape and a plurality of compressed shapes. For example, spring 550 may assume a completely relaxed shape when no forces act on spring 550 to hold it in compression. In the embodiment of FIG. 8, spring 550 is pictured having a somewhat compressed shape relative to its relaxed shape.

Base 588 of apparatus 500 is coupled to a first outer rail 520 and a second outer rail 524. A flange 538 of apparatus 500 is also coupled to first outer rail 520 and second outer rail 524. A wheel 534 of a balance mechanism 506 is pivotally supported by flange 538, first outer rail 520 and second outer rail 524. In the embodiment of FIG. 8, balance mechanism 506 is coupled between a first inner rail 508 and a first outer rail 520. Balance mechanism 506 may advantageously provide a balancing force between first inner rail 508 and first outer rail 520. In the embodiment of FIG. 8, the balancing force provided by balance mechanism 506 can be adjusted by rotating adjustment screw 590.

In the embodiment of FIG. 8, wheel 534 of balance mechanism comprises a cam member 542 that is coupled to spring 550 by a first cable 562 and a bottom spring plate 552. In some useful embodiments of the present invention, cam member 542 is shaped and positioned so that a torque applied to wheel 534 by spring 550 is substantially constant while a force applied to wheel 534 by spring 550 varies. The force provided by spring 550 may vary, for example, as the deflection of spring 550 varies.

In the embodiment of FIG. 8, wheel 534 comprises a pulley member 540 that is coupled to first inner rail 508 of first slide 502 by a bracket 546 and a second cable 544. Accordingly, wheel 534 may be urged to rotate in a counter-clockwise direction 548 by moving distal end 526 of first inner rail 508 toward distal end 527 of first outer rail 520. In some useful embodiments of the present invention, second cable 544 applies a substantially constant balancing force to first inner rail 508.

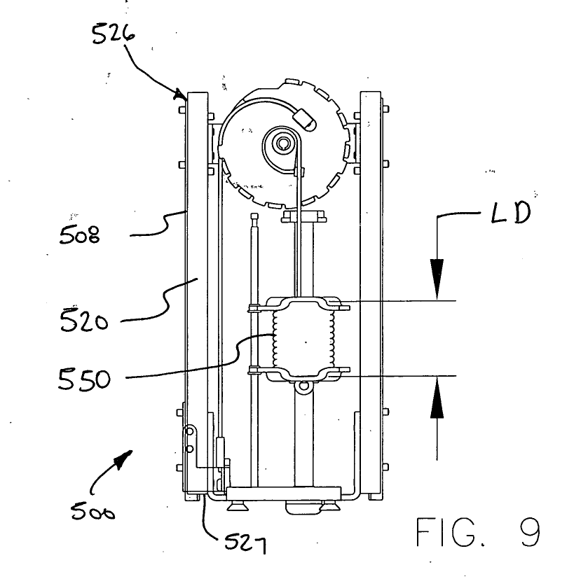

FIG. 9 is an additional elevation view of apparatus 500 shown in the previous figure. In the embodiment of FIG. 9, apparatus 500 is shown in a generally retracted state in which distal end 526 of first inner rail 508 is located closer to distal end 527 of first outer rail 520 (relative to the state shown in the previous figure). An over-all length of spring 550 is labeled LD in FIG. 9. In FIG. 9, spring 550 is shown assuming a shape that is more compressed than the shape shown in the previous figure. Accordingly, length LD shown in FIG. 9 is generally smaller than length LC shown in the previous figure.

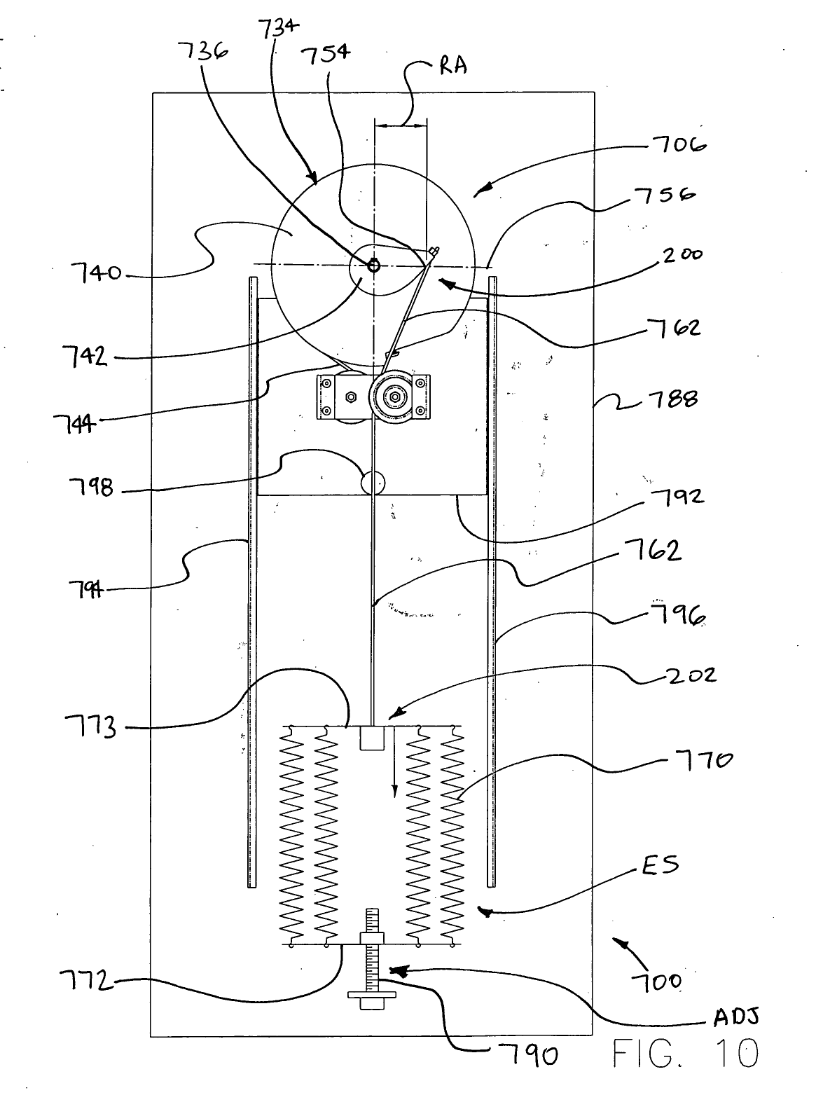

FIG. 10 is a front view of an apparatus 700 in accordance with an additional exemplary embodiment of the present invention. Apparatus 700 comprises a base 788 and a trolley 792 that is preferably free to move relative to base 788. In the embodiment of FIG. 10, the motion of trolley 792 is guided by a first guide 794 and a second guide 796.

Apparatus 700 also comprises a balance mechanism 706 for providing a balancing force between trolley 792 and base 788. In the embodiment of FIG. 10, balance mechanism 706 includes a wheel 734 comprising a pulley member 740 and a cam member 742. In the embodiment of FIG. 10, a second cable 744 is shown extending between the pulley member 740 and trolley 792. Second cable 744 is attached to trolley 792 at an anchor 798. Anchor 798 is represented by a circle in FIG. 10.

Apparatus 700 also comprises a first cable 762 having a first end 200 and a second end 202. Second end 202 of first cable 762 is represented by a square in FIG. 10. In the embodiment of FIG. 10, first end 200 of a first cable 762 is connected to cam member 742 of wheel 734. A force F is shown acting on first cable 762 proximate second end 202 thereof.

In the embodiment of FIG. 10, apparatus 700 first cable 762 connects the cam member of the wheel to an energy source ES for biasing the wheel to rotate in a first direction. In some useful embodiments of the present invention, the cam member is shaped and positioned so that a torque applied to the wheel by the first cable is substantially constant or varied in a pre-determined manner while an output of the energy source varies.

In the embodiment of FIG. 10, energy source ES comprises a plurality of extension springs 770. In this exemplary embodiment, the output of energy source ES may vary as a function of a deflection of the extension springs 770. Apparatus 700 of FIG. 10 also includes an adjustment mechanism ADJ that may be used to vary an output of energy source ES. With reference to FIG. 10, it will be appreciated that extension springs 770 extend between a bottom spring plate 772 and a top spring plate 773. Bottom spring plate 772 is coupled to a base 788 of apparatus 700 by an adjustment screw 790. The position of bottom spring plate 772 relative to base 788 can be adjusted by rotating adjustment screw 790.

In the embodiment of FIG. 10, wheel 734 is pivotally supported by base 788 so that wheel 734 pivots about a pivot axis 736. In FIG. 10, first cable 762 is shown contacting cam member 742 at a first intersection 754. A first reference line 756 is shown passing through pivot axis 736 of wheel 734 and first intersection 754 in FIG. 10. In the embodiment of FIG. 10, first intersection 754 and pivot axis 736 are separated by a first radius RA.

In some useful embodiments of the present invention, cam member 742 is shaped and positioned so that a torque applied to wheel 734 by first cable 762 is substantially constant while a force applied to wheel 734 by first cable 762 varies. In some embodiments of the present invention, for example, the effective radius of cam member 742 varies as a function of the angular orientation of wheel 734. Also in some useful embodiments of the present invention, the effective radius of cam member 742 may vary as a function of the displacement of a spring of balance mechanism 706.

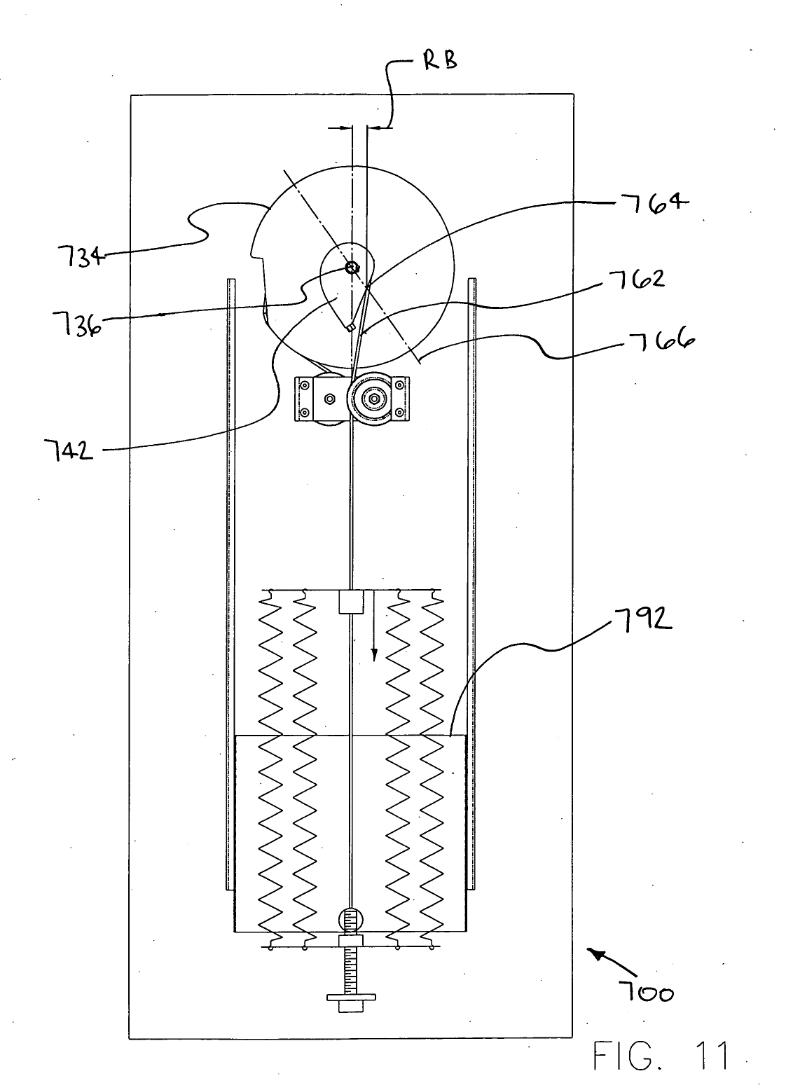

FIG. 11 is an additional front view of apparatus 700 shown in the previous figure. With reference to the figures, it will be appreciated wheel 734 has a first angular orientation corresponding to a first position of trolley 792 and a second angular orientation corresponding to a second position of trolley 792. The first position of trolley 792 is shown in the previous figure and the second position of trolley 792 is shown in FIG. 11.

In FIG. 11, first cable 762 is shown contacting cam member 742 at a second intersection 764. A second reference line 766 is shown passing through pivot axis 736 of wheel 734 and second intersection 764 in FIG. 11. In the embodiment of FIG. 10, second intersection 764 and pivot axis 736 are separated by a second radius RB. With reference to the figures, it will be appreciated that radius RB is generally smaller than radius RA shown in the previous figure.

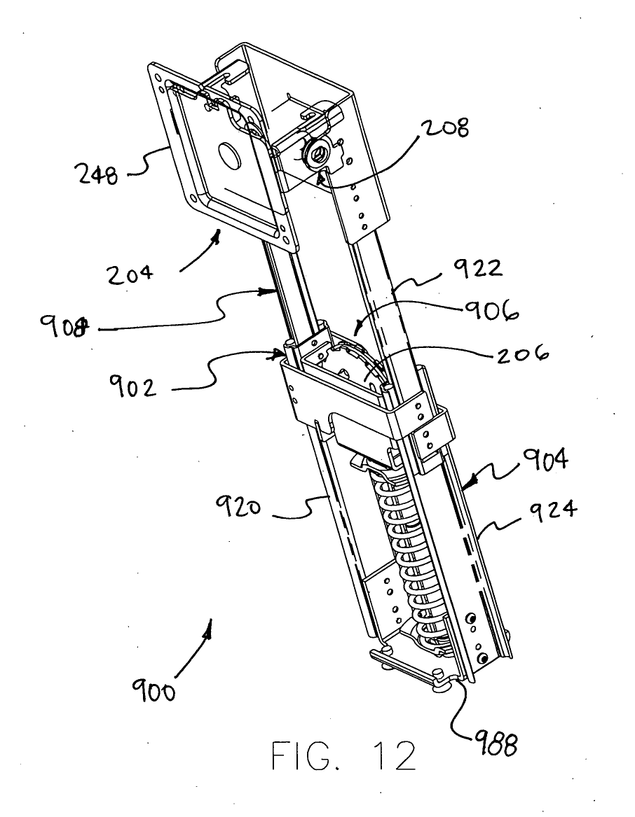

FIG. 12 is a perspective view of an apparatus 900 in accordance with an exemplary embodiment of the present invention. Apparatus 900 of FIG. 12, comprises a head 204 that is slidingly coupled to a base 988 by a first slide 902 and a second slide 904. In the embodiment of FIG. 12, head 204 is connected to a first inner rail 908 of a first slide 902 and a second inner rail 922 of a second slide 904. In FIG. 12, base 988 is shown connected to a first outer rail 920 of first slide 902 and a second outer rail 924 of second slide 904. Apparatus 900 of FIG. 12 also includes a balance mechanism 906 that is coupled between base 988 and head 204 for providing a balancing force. In the embodiment of FIG. 12, balance mechanism 906 comprises a wheel 206.

A mounting bracket 248 is coupled to head 204 by a pivot mechanism 208 in the embodiment of FIG. 12. A device such as, for example, an electronic display may be fixed to mounting bracket 248 so that apparatus 900 supports the device at a desired position. In the embodiment of FIG. 12, pivot mechanism 208 advantageously provides a tilting motion to mounting bracket 248 so that mounting bracket 248 can be arranged at a desired angle of tilt. In a preferred embodiment, head 204 and base 988 are moveable relative to one another for selectively repositioning the device. For example, head 204 may be raised and lowered relative to base 988.

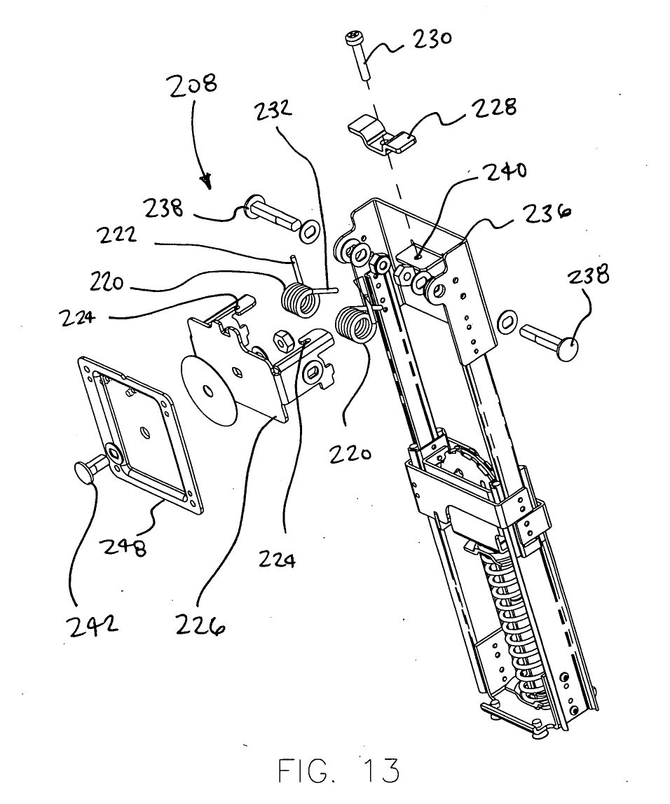

FIG. 13 is an exploded view of apparatus 900 shown in the previous figure. In FIG. 13, it may be appreciated that pivot mechanism 208 comprises a plurality of torsion springs 220. A first leg 222 of each torsion spring 220 engages a notch 224 defined by a first structural member 226. An adjustment plate 228 engages a second leg 232 of each torsion spring 220. A tilt adjust screw 230 may be used to adjust the position of second leg 232 of each torsion spring 220.

First structural member 226 may be pivotally attached to a second structural member 236 by a plurality of bolts 238. In FIG. 13, it may be appreciated that second structural member 236 defines a threaded hole 240. Threaded hole 240 is preferably adapted to receive tilt adjust screw 230. A mounting bracket 248 may be pivotally connected to first structural member 226 by a bolt 242.

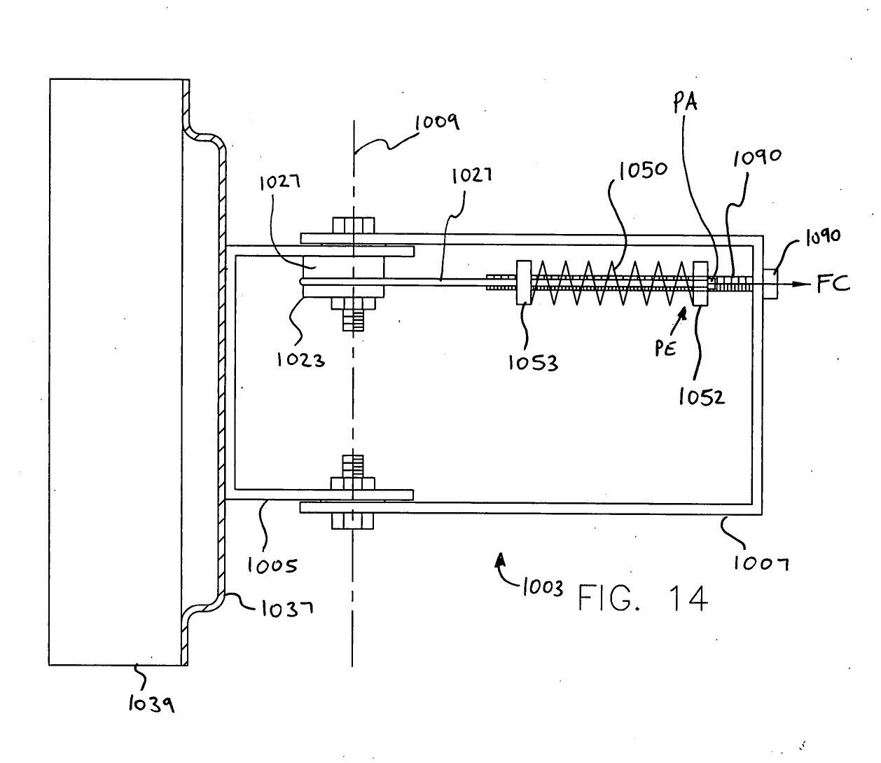

FIG. 14. is a top view of a pivot mechanism 1003 in accordance with an additional exemplary embodiment of the present invention. Pivot mechanism 1003 comprises a first bracket 1005 and a second bracket 1007. First bracket 1005 and second bracket 1007 are arranged so that they are capable of pivoting relative to one another. A pivot axis 1009 of first bracket 1005 and second bracket 1007 is shown in FIG. 14. In the embodiment of FIG. 14, a cam 1023 is fixed to first bracket 1005. In FIG. 14, a cable 1025 is shown resting on an outer surface 1027 of cam 1023.

Pivot mechanism 1003 comprises a spring 1050 that is disposed between a proximal spring plate 1052 and a distal spring plate 1053. Distal spring plate 1053 is coupled to second bracket 1007 by an adjustment screw 1090. In the embodiment of FIG. 14, spring 1050 is capable of assuming a relaxed shape and a plurality of compressed shapes. For example, spring 1050 may assume a completely relaxed shape when no forces act on spring 1050 to hold it in compression. In the embodiment of FIG. 14, spring 1050 is pictured having a somewhat compressed shape relative to its relaxed shape. In some useful embodiments of the present invention, an adjustment mechanism can be used to alter the preload on a spring. Altering the preload on a spring may alter the spring rate of the spring. In the embodiment of FIG. 14, adjustment screw 1090 threadingly engages distal spring plate 1053 so that a distance between distal spring plate 1053 and proximal spring plate 1052 can be adjusted by rotating adjustment screw 1090.

In FIG. 14, cable 1025 is shown extending through distal spring plate 1053 and proximal spring plate 1052. A proximal anchor PA is fixed to the proximal end of cable 1025. In the embodiment of FIG. 14, proximal anchor PA is seated against proximal spring plate 1052. A force FC is shown acting on proximal anchor PA. A proximal end PE of spring 1050 is seated against proximal spring plate 1052. In the embodiment of FIG. 14, spring 1050 and cable 1025 cooperate to apply force FC to cam 1023. A mounting plate 1037 is fixed to first bracket 1005 in the embodiment of FIG. 14. In FIG. 14, a load 1039 is shown fixed to mounting plate 1037.

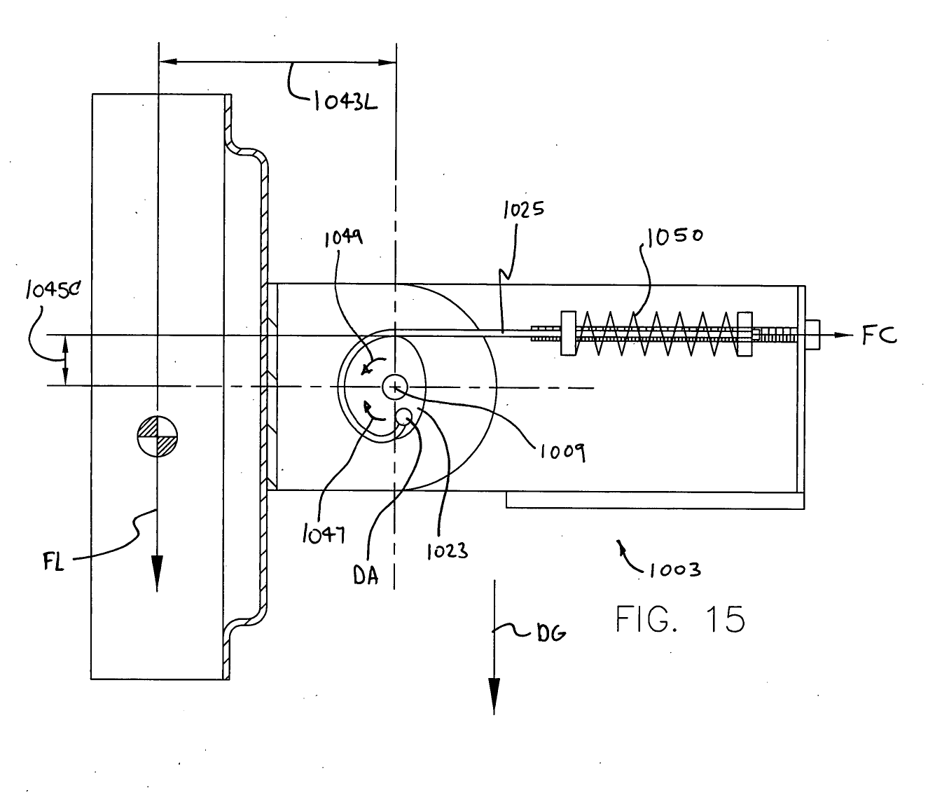

FIG. 15 is a side view of pivot mechanism 1003 shown in the previous figure. In FIG. 15, the effect of gravity on load 1039 is illustrated using an arrow FL. A direction of gravitational pull is illustrated using an arrow labeled DG in FIG. 15. With reference to FIG. 15, it will be appreciated that the arrow labeled FL and the arrow labeled DG are generally parallel to one another. A horizontal distance between the center of gravity of load 1039 and pivot axis 1009 is illustrated using dimension lines in FIG. 15. In the embodiment of FIG. 15, this horizontal distance generally corresponds with an effective moment arm 1043L of load 1039. A load moment 1049 is illustrated using a curved arrow in FIG. 15. In the embodiment of FIG. 15, load moment 1049 is generally equal to the weight of load 1039 multiplied by the effective moment arm 1043L of load 1039.

In the embodiment of FIG. 15, cable 1025 and cam 1023 are coupled to one another at a distal anchor DA. Also in the embodiment of FIG. 15, cable 1025 and cam 1023 cooperate with one another to apply a balancing moment 1047 about pivot axis 1009. In FIG. 15, a cable force FC is shown acting on cable 1025. In the embodiment of FIG. 15, cable force FC acts on cam 1023 with an effective moment arm 1045C. The length of effective moment arm 1045C is shown with dimension lines in FIG. 15. In some embodiments of the present invention, cam 1023 is shaped so that balancing moment 1047 is substantially equal to load moment 1049 as first bracket 1005 rotates through a range of motion. Also in some embodiments of the present invention, the radius of cam 1023 varies as a function of a spring rate of spring 1050.

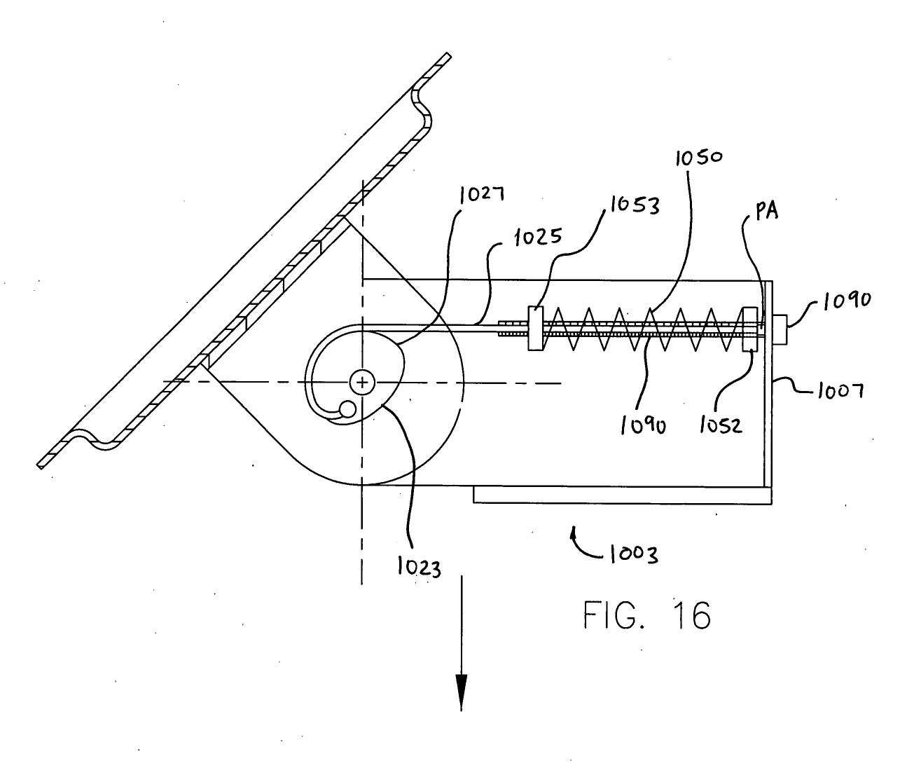

FIG. 16 is an additional side view of pivot mechanism 1003 shown in the previous figure. In FIG. 16, cable 1025 is shown resting on an outer surface 1027 of cam 1023. In FIG. 16, cable 1025 is shown extending through distal spring plate 1053 and proximal spring plate 1052. A proximal anchor PA is fixed to the proximal end of cable 1025. In the embodiment of FIG. 16, proximal anchor PA is seated against a wall of second bracket 1007.

Pivot mechanism 1003 comprises a spring 1050 that is disposed between proximal spring plate 1052 and distal spring plate 1053. Distal spring plate 1053 is coupled to second bracket 1007 by adjustment screw 1090. In the embodiment of FIG. 16, spring 1050 is capable of assuming a relaxed shape and a plurality of compressed shapes. For example, spring 1050 may assume a completely relaxed shape when no forces act on spring 1050 to hold it in compression. In the embodiment of FIG. 16, spring 1050 is pictured having a somewhat compressed shape relative to its relaxed shape. Also in the embodiment of FIG. 16, spring 1050 is pictured having a somewhat more relaxed shape than the shape shown in the previous figure. In some useful embodiments of the present invention, an adjustment mechanism can be used to alter the preload on a spring. Altering the preload on a spring may alter the spring rate of the spring. In the embodiment of FIG. 16, adjustment screw 1090 threadingly engages distal spring plate 1053 so that a distance between distal spring plate 1053 and proximal spring plate 1052 can be adjusted by rotating adjustment screw 1090.

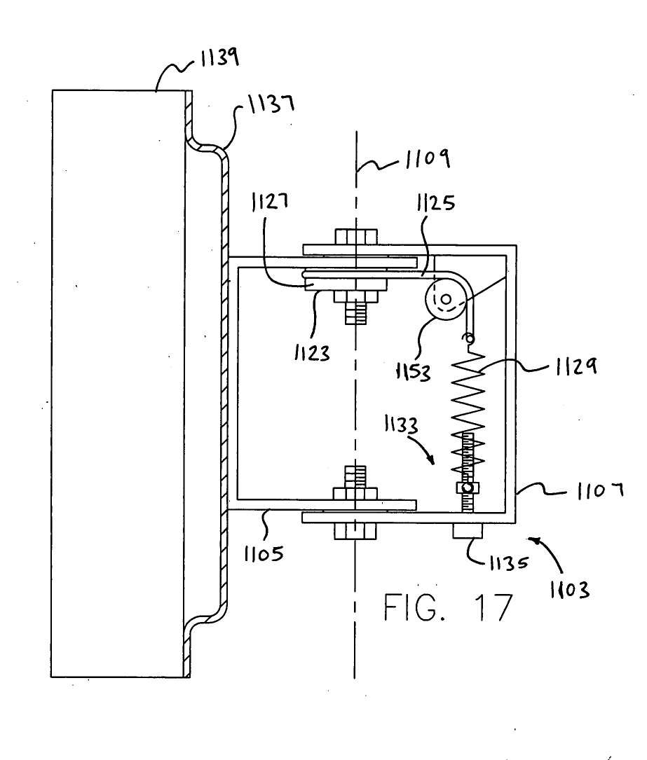

FIG. 17 is a top view of a pivot mechanism 1103 in accordance with an additional exemplary embodiment of the present invention. Pivot mechanism 1103 comprises a first bracket 1105 and a second bracket 1107. First bracket 1105 and second bracket 1107 are arranged so that they are capable of pivoting relative to one another. A pivot axis 1109 of first bracket 1105 and second bracket 1107 is illustrated using a dashed line in FIG. 17. In the embodiment of FIG. 17, a cam 1123 having an outer surface 1127 is fixed to first bracket 1105. A cable 1125 is shown extending between cam 1123 and a spring 1129. With reference to FIG. 17, it will appreciated that cable 1125 wraps partially around a pulley 1153. A proximal end of spring 1129 is attached to a screw mechanism 1133. Screw mechanism can be used to vary the position of the proximal end of spring 1129. Screw mechanism 1133 comprises a screw 1135 that extends through a portion of second bracket 1107. A mounting plate 1137 is fixed to first bracket 1105 in the embodiment of FIG. 17. In FIG. 17, a load 1139 is shown fixed to mounting plate 1137.

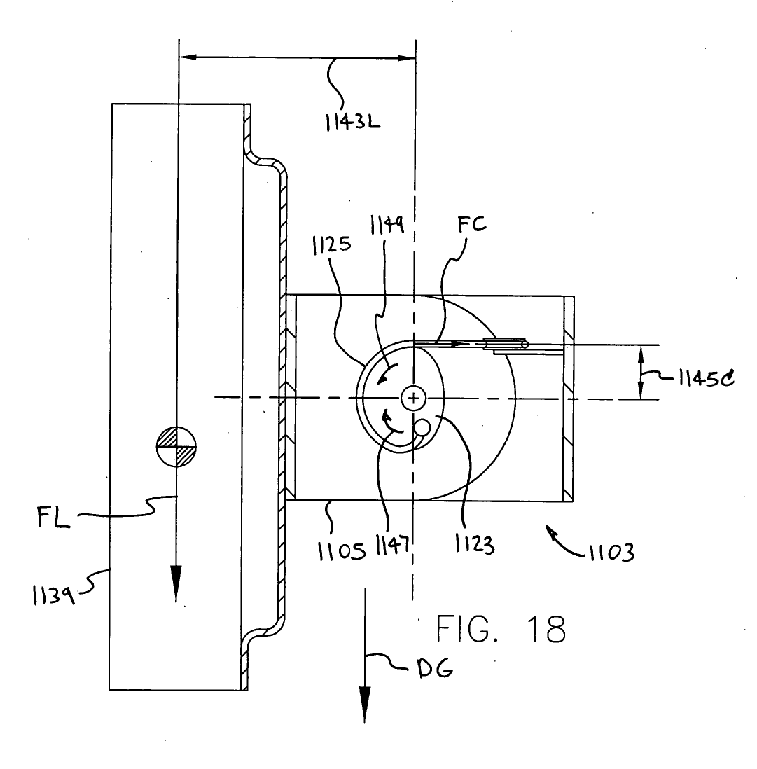

FIG. 18 is a side view of pivot mechanism 1103 shown in the previous figure. In the embodiment of FIG. 18, first bracket 1105 and load 1139 may be pivoted to assume various orientations. In FIG. 18, load 1139 and first bracket 1105 are disposed in a first orientation. In FIG. 18, a cable force FC is shown acting on cam 1123 via cable 1125. In the embodiment of FIG. 18, cable 1125 cooperates with cam 1123 to produce a balancing moment 1147. In the embodiment of FIG. 18, balancing moment 1147 is generally equal to cable force FC multiplied by a first effective moment arm 1145C. The length of the first effective moment arm 1145C is illustrated using dimension lines in FIG. 18. As illustrated in FIG. 18, the first effective moment arm 1145C of cam 1123 is measured in a direction that is generally perpendicular to the direction of cable force FC.

In FIG. 18, the effect of gravity on load 1139 is illustrated using an arrow FL. A direction of gravitational pull is illustrated using an arrow labeled DG in FIG. 18. With reference to FIG. 18, it will be appreciated that the arrow labeled FL and the arrow labeled DG are generally parallel to one another. A load moment 1149 is illustrated using a curved arrow in FIG. 18. In the embodiment of FIG. 18, load moment 1149 is generally equal to the force FL multiplied by a first effective moment arm 1143L of load 1139. The first effective moment arm 1143L of load 1139 is shown with dimension lines in FIG. 18. As illustrated in FIG. 18, the first effective moment arm 1143L of load 1139 is measured in a direction that is generally perpendicular to the direction of force FL. In some embodiments of the present invention, cam 1123 is shaped so that balancing moment 1147 is substantially equal in magnitude to load moment 1149 as first bracket 1105 rotates through a range of motion. In the embodiment of FIG. 18, first cable force FC multiplied by first effective moment arm 1145C is equal in magnitude to force FL multiplied by first effective moment arm 1143L while first bracket 1105 is assuming the first orientation.

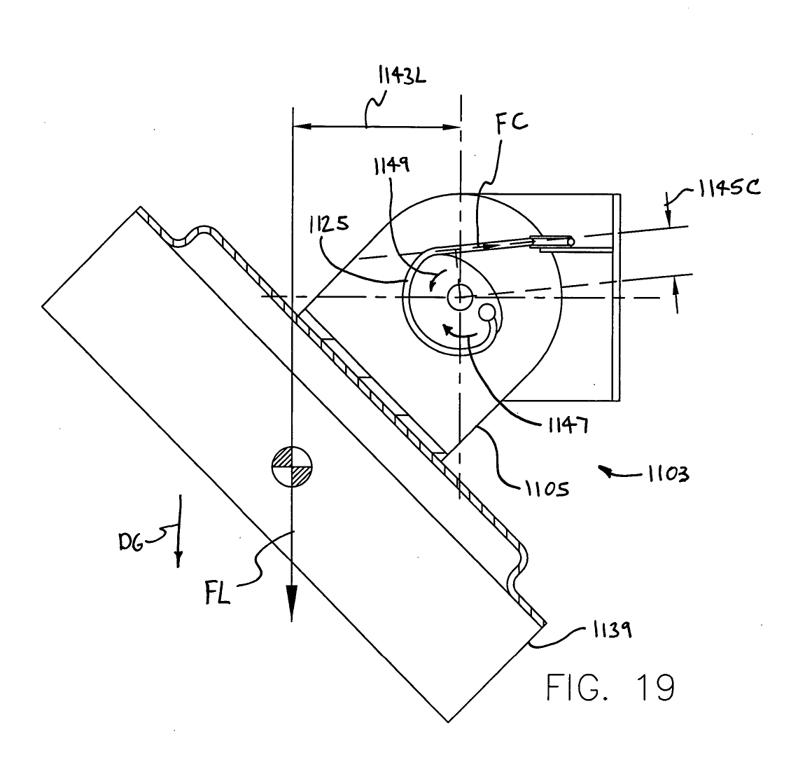

FIG. 19 is an additional side view of pivot mechanism 1103 shown in the previous figure. With reference to FIG. 19, it will be appreciated that first bracket 1105 and load 1139 have been rotated to a second orientation different from the first orientation shown in the previous figure. In FIG. 19, a cable force FC is shown acting on cam 1123 via cable 1125. In the embodiment of FIG. 19, cable 1125 cooperates with cam 1123 to produce a balancing moment 1147. In the embodiment of FIG. 19, balancing moment 1147 is generally equal to cable force FC multiplied by a second effective moment arm 1145C of cam 1123. The second effective moment arm 1145C of cam 1123 is shown with dimension lines in FIG. 19. As illustrated in FIG. 19, the second effective moment arm 1145C of cam 1123 is measured in a direction that is generally perpendicular to the direction of cam force FC.

In FIG. 19, the effect of gravity on load 1139 is illustrated using an arrow FL. A direction of gravitational pull is illustrated using an arrow labeled DG in FIG. 19. With reference to FIG. 19, it will be appreciated that the arrow labeled FL and the arrow labeled DG are generally parallel to one another. A load moment 1149 is illustrated using a curved arrow in FIG. 19. In the embodiment of FIG. 19, load moment 1149 is generally equal to the force FL multiplied by a second effective moment arm 1143L of load 1139. Second effective moment arm 1143L is shown with dimension lines in FIG. 19. As illustrated in FIG. 19, the second effective moment arm 1143L of load 1139 is measured in a direction that is generally perpendicular to the direction of force FL.

In some embodiments of the present invention, cam 1123 is shaped so that balancing moment 1147 is substantially equal in magnitude to load moment 1149 as first bracket 1105 rotates through a range of motion. In the embodiment of FIG. 19, first cable force FC multiplied by first effective moment arm 1145C is equal in magnitude to force FL multiplied by first effective moment arm 1143L while first bracket 1105 is assuming the first orientation. Also in the embodiment of FIG. 19, second cable force FC multiplied by second effective moment arm 1145C is equal in magnitude to force FL of load 1139 multiplied by second effective moment arm 1143L while first bracket 1105 is assuming the second orientation.

With reference to FIG. 19, it will be appreciated that as load 1139 and first bracket 1105 are pivoted in a counter clockwise direction, effective moment arm 1143L becomes shorter and effective moment arm 1145C also becomes shorter. Additionally, as load 1139 and first bracket 1105 rotate in a clockwise direction about pivot axis 1109, effective moment arm 1143L becomes longer and effective moment arm 1145C also becomes longer.

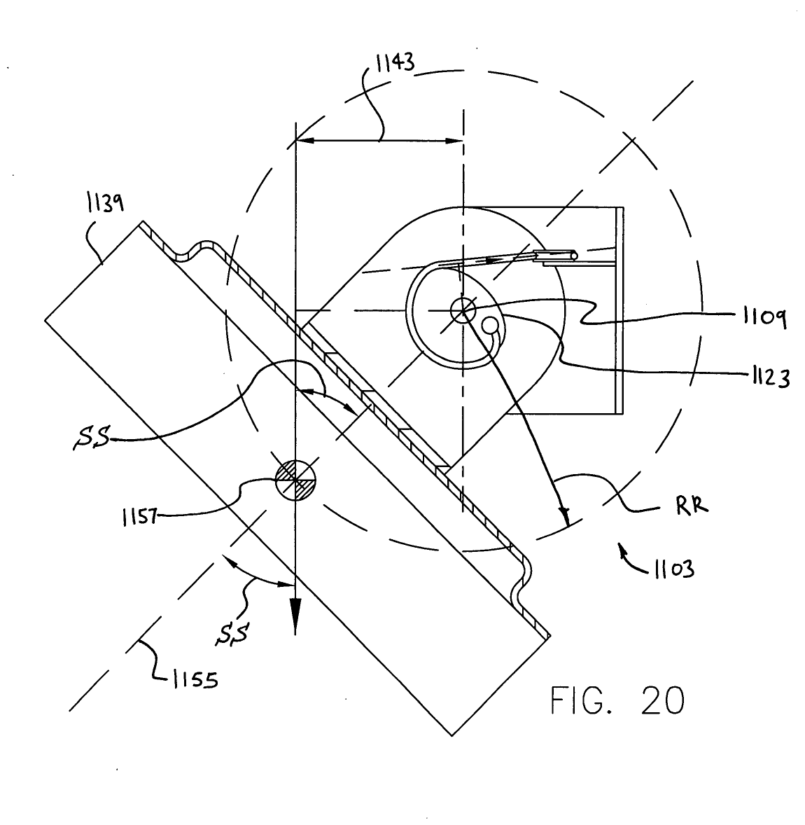

FIG. 20 is an additional side view of pivot mechanism 1103 shown in the previous figure. In FIG. 20, a reference line 1155 is shown extending through pivot axis 1109 and the center of gravity 1157 of load 1139. An angle SS is defined by the direction of load force FL and reference line 1155. This angle may be referred to as an orientation angle. A radius RR defined by pivot axis 1109 and the center of gravity 1157 of load 1139 is also illustrated in FIG. 20. With reference to FIG. 20, it will be appreciated that the effective moment arm 1143L of load 1139 is generally equal to radius RR multiplied by sin(SS). In some embodiments of the present invention, a radius of cam 1123 varies as a function of sin(SS).

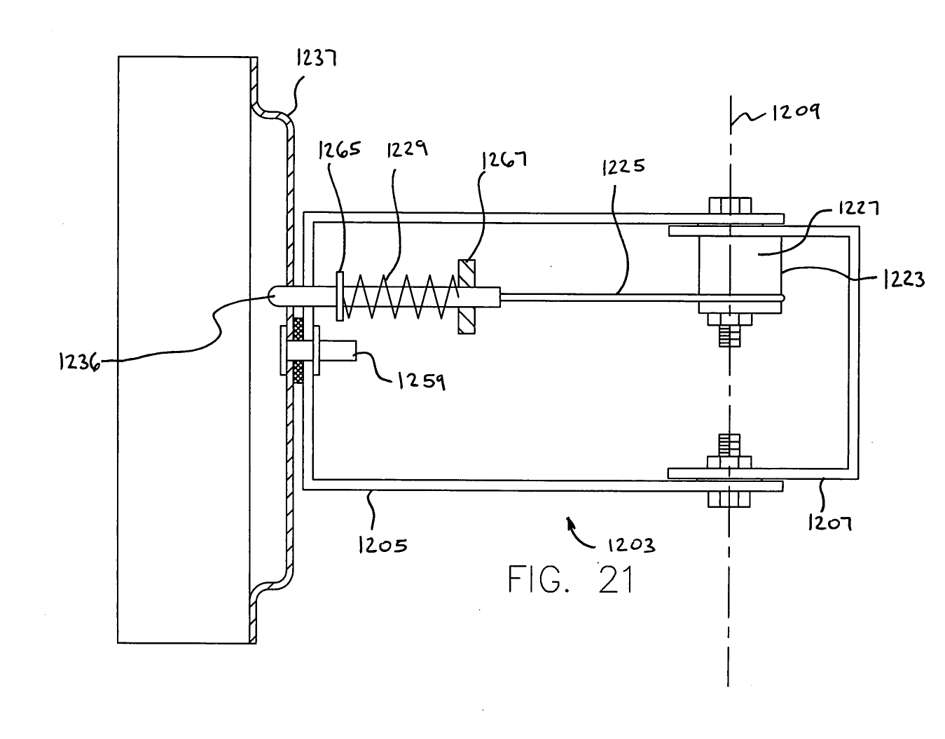

FIG. 21 is a top view of a pivot mechanism 1203 in accordance with an additional exemplary embodiment of the present invention. Pivot mechanism 1203 comprises a first bracket 1205 and a second bracket 1207. First bracket 1205 and second bracket 1207 are arranged so that they are capable of pivoting relative to one another. A pivot axis 1209 of first bracket 1205 and second bracket 1207 is shown in FIG. 21. In the embodiment of FIG. 21, a cam 1223 is fixed to second bracket 1207. In FIG. 21, cable 1225 is shown resting on an outer surface 1227 of cam 1223. A cable 1225 is shown extending between cam 1223 and a spring 1229.

In the embodiment of FIG. 21, a mounting plate 1237 is connected to first bracket 1205 by an axle 1259. Axle 1259 is shown extending through mounting plate 1237 and a wall of first bracket 1205. In the embodiment of FIG. 21, a pin 1263 is shown extending through a wall of first bracket 1205 and through mounting plate 1237. When pin 1263 is disposed in the position shown in FIG. 21, pin 1263 prevents mounting plate 1237 from rotating about the longitudinal axis of axle 1259. Pin 1263 comprises a shoulder 1265. A first end of spring 1229 is shown seated against shoulder 1265 of pin 1263. A second end of spring 1229 is seated against a flange 1267 of first bracket 1205. Spring 1229 serves to bias pin 1263 toward mounting plate 1237. In the embodiment of FIG. 21, cable 1225 is connected to one end of pin 1263.

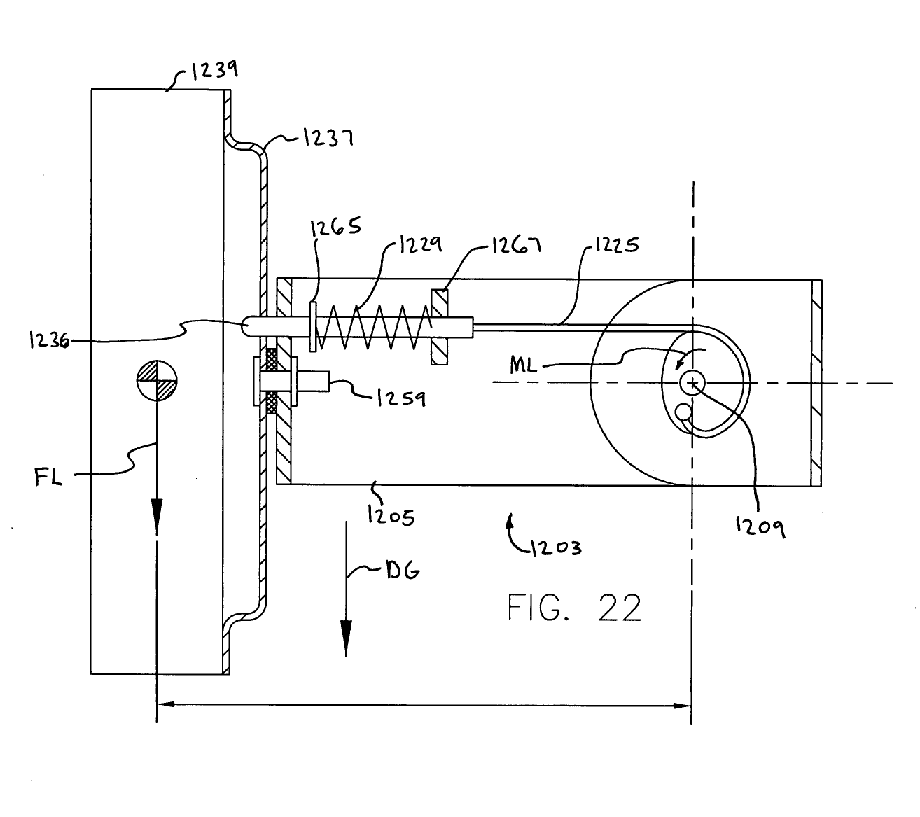

FIG. 22 is a side view of pivot mechanism 1203 shown in the previous figure. In the embodiment of FIG. 22 a load 1239 is fixed to mounting plate 1237. The effect of gravity on load 1239 is illustrated using an arrow FL. A direction of gravitational pull is illustrated using an arrow labeled DG in FIG. 22. With reference to FIG. 22, it will be appreciated that the arrow labeled FL and the arrow labeled DG are generally parallel to one another. The distance between the center of gravity of load 1239 and pivot axis 1209 is illustrated using dimension lines in FIG. 22. A load moment ML is illustrated using a curved arrow in FIG. 22. Load moment ML is produced by the weight of load 1239.

In the embodiment of FIG. 22, mounting plate 1237 is connected to first bracket 1205 by an axle 1259. Axle 1259 is shown extending through mounting plate 1237 and a wall of first bracket 1205. In the embodiment of FIG. 22, a pin 1263 is shown extending through the wall of first bracket 1205 and mounting plate 1237. When pin 1263 is disposed in the position shown in FIG. 22, pin 1263 prevents mounting plate 1237 from rotating about the longitudinal axis of axle 1259. Pin 1263 comprises a shoulder 1265. A first end of spring 1229 is shown seated against shoulder 1265 of pin 1263. A second end of spring 1229 is seated against a flange 1267 of first bracket 1205. Spring 1229 serves to bias pin 1263 toward mounting plate 1237. A cable 1225 is connected to one end of pin 1263.

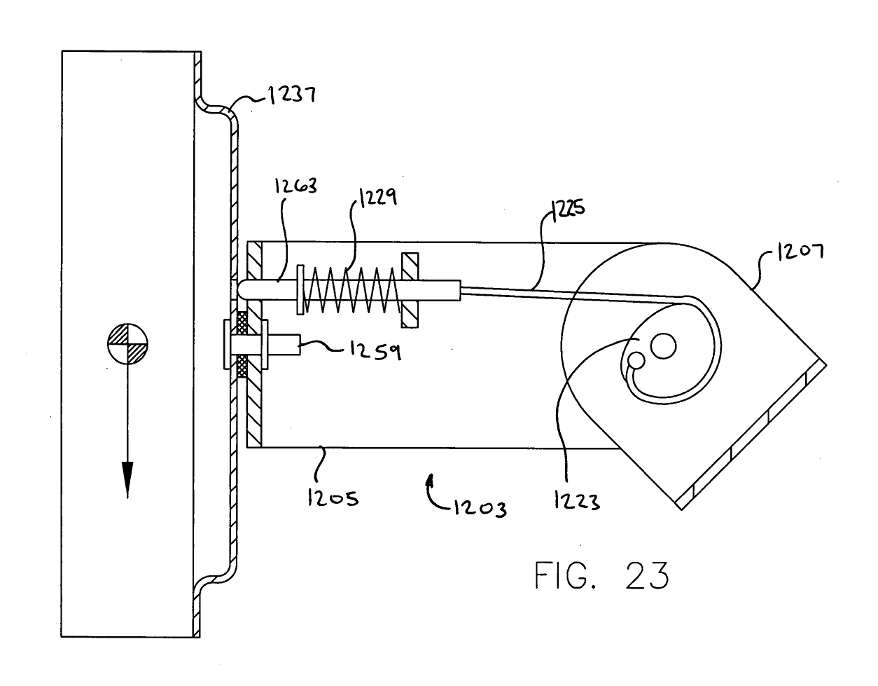

FIG. 23 is an additional side view of pivot mechanism 1203 shown in the previous figure. In the embodiment of FIG. 23, second bracket 1207 is disposed in a position different than that shown in the previous figure. With reference to FIG. 23, it will be appreciated that cable 1225 has urged spring 1229 to assume a more compressed shape relative to the shape shown in the previous figure. Also with reference to FIG. 23, it will be appreciated that pin 1263 has assumed a withdrawn position. In the embodiment of figure 23, mounting plate 1237 is free to rotate about the longitudinal axis of axle 1259 when pin 1263 assumes the withdrawn position.

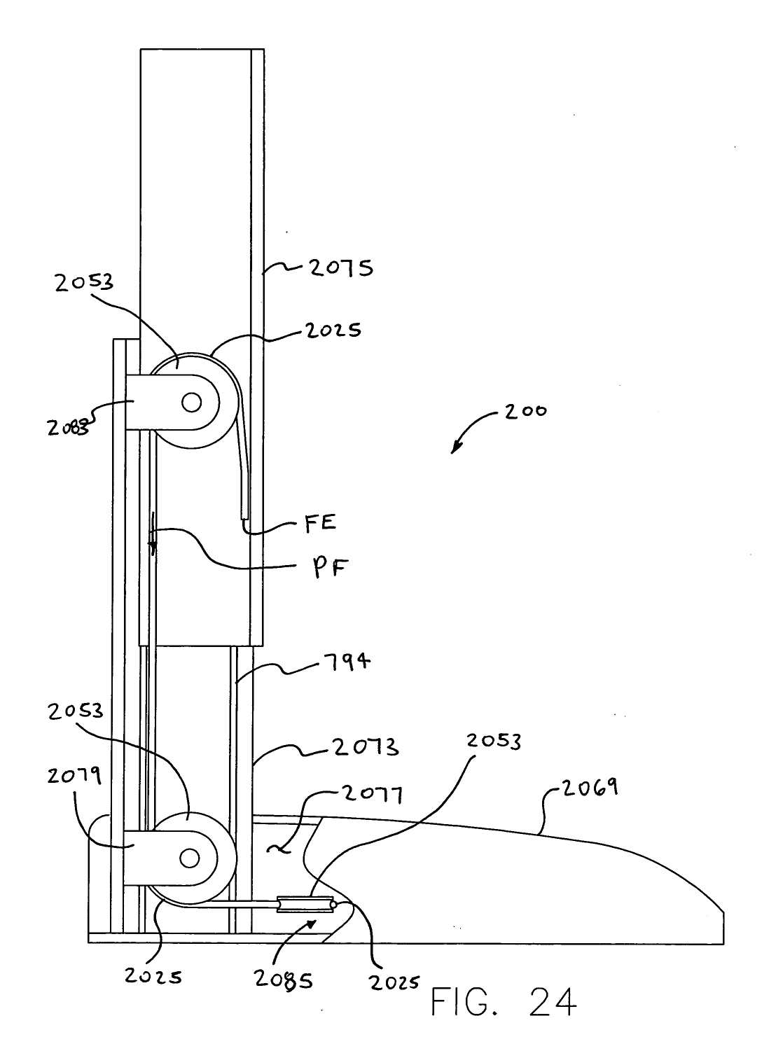

FIG. 24 is an elevation view of an apparatus 2000 in accordance with an additional exemplary embodiment of the present invention. Apparatus 2000 comprises a first leg 2073 and a second leg 2075 that is preferably free to move relative to first leg 2073. In the embodiment of FIG. 24, the motion of second leg 2075 is guided by a first guide 794 and a second guide (not shown in FIG. 24). In the embodiment of FIG. 24, first leg 2073 is fixed to a base 2069. With reference to FIG. 24, it will be appreciated that base 2069 defines a cavity 2077. Apparatus 2000 also comprises a balancing mechanism 2085 for providing a balancing force between second leg 2075 and first leg 2073. In the embodiment of FIG. 24, balancing mechanism 2085 is disposed within cavity 2077.

A first mount 2079 and a second mount 2083 are fixed to first leg 2073. First mount 2079 and second mount 2083 pivotally support a first pulley 2053 and a second pulley 2053, respectively. A third pulley 2053 is also visible in FIG. 24. Third pulley 2053 is pivotally supported by base 2069. A cable 2025 is shown extending around first pulley 2053, second pulley and third pulley 2053. Balancing mechanism 2085 provides a pulling force PF on cable 2025. Accordingly, cable 2025 provides a balancing force between second leg 2075 and first leg 2073. In FIG. 24, a first end FE of cable 2025 is fixed to second leg 2075.

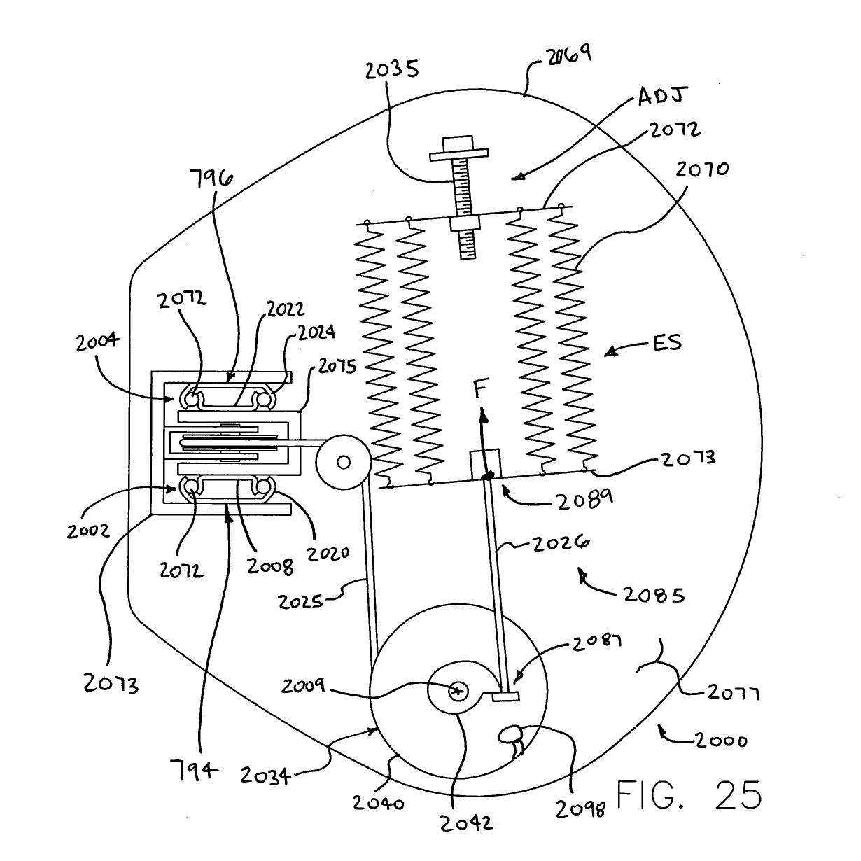

FIG. 25 is a bottom view of apparatus 2000 shown in the previous figure. With reference to FIG. 25, it will be appreciated that balancing mechanism 2085 is disposed within a cavity 2077 defined by base 2069. In the embodiment of FIG. 25, balancing mechanism 2085 includes a wheel 2034 comprising a pulley member 2040 and a cam member 2042. In the embodiment of FIG. 25, a first cable 2025 is shown extending between the pulley member 2040 and second leg 2075. First cable 2025 is attached to pulley member 2040 at an anchor 2098. Anchor 2098 is represented by a circle in FIG. 25.

Apparatus 2000 also comprises a second cable 2026 having a first end 2087 and a second end 2089. Second end 2089 of second cable 2026 is represented by a square in FIG. 25. In the embodiment of FIG. 25, first end 2087 of a second cable 2026 is connected to cam member 2042 of wheel 2034. A force F is shown acting on second cable 2026 proximate second end 2089 thereof.

In the embodiment of FIG. 25, second cable 2026 connects the cam member of the wheel to an energy source ES for biasing the wheel to rotate in a first direction. In some useful embodiments of the present invention, the cam member is shaped and positioned so that a torque applied to the wheel by the second cable is substantially constant or varied in a pre-determined manner while an output of the energy source varies.

In the embodiment of FIG. 25, energy source ES comprises a plurality of extension springs 2070. In this exemplary embodiment, the output of energy source ES may vary as a function of a deflection of the extension springs 2070. Apparatus 2000 of FIG. 25 also includes an adjustment mechanism ADJ. With reference to FIG. 25, it will be appreciated that extension springs 2070 extend between a bottom spring plate 2072 and a top spring plate 2073. Bottom spring plate 2072 is coupled to base 2069 of apparatus 2000 by an adjustment screw 2035. The position of bottom spring plate 2072 relative to base 2069 can be adjusted by rotating adjustment screw 2035. In the embodiment of FIG. 25, wheel 2034 is pivotally supported by base 2069 so that wheel 2034 pivots about a pivot axis 2009.

Apparatus 2000 also comprises a first leg 2073 and a second leg 2075 that is preferably free to move relative to first leg 2073. In the embodiment of FIG. 24, the motion of second leg 2075 is guided by a first guide 794 and a second guide 796. In the embodiment of FIG. 24, first guide 794 and second guide 796 comprise a first slide 2002 and a second slide 2004 respectively. First slide 2002 comprises a first inner rail 2008 and a first outer rail 2020. With reference to FIG. 24, it may be appreciated that a plurality of balls 2072 are disposed between first inner rail 2008 and first outer rail 2020. Second slide 2004 comprises a second inner rail 2022, a second outer rail 2024 and a plurality of balls 2072 disposed therebetween.

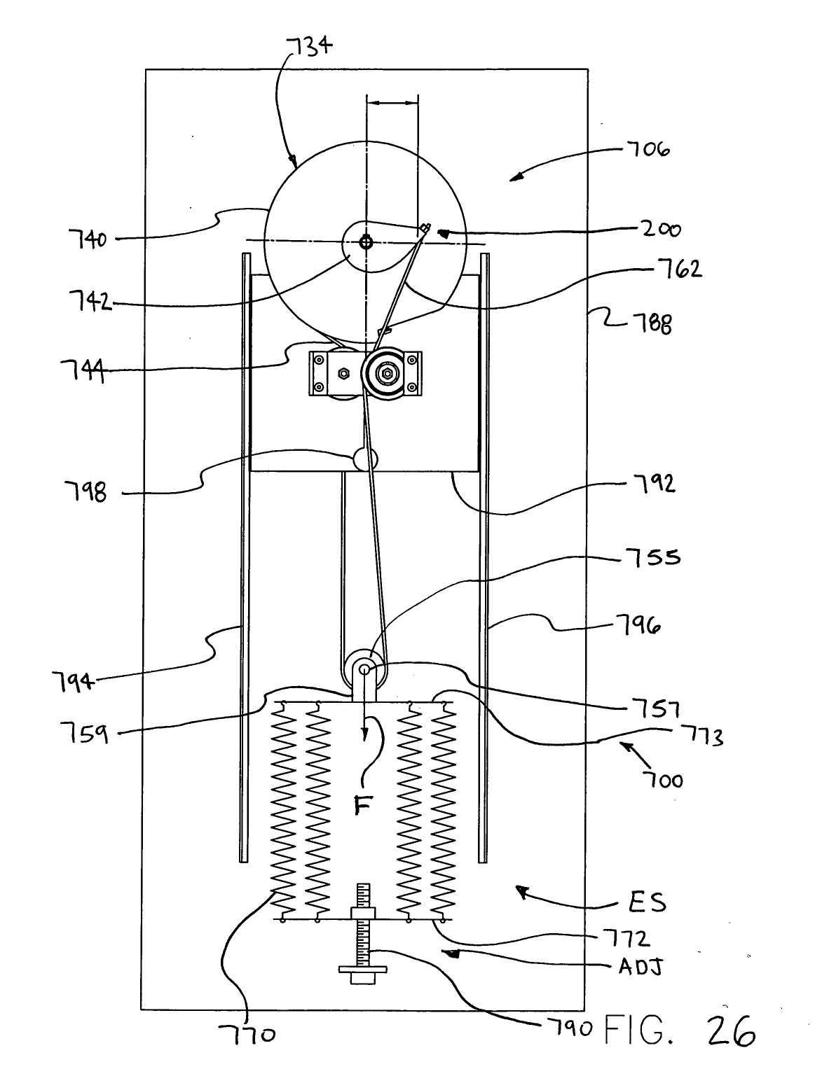

FIG. 26 is a front view of an apparatus 700 in accordance with an additional exemplary embodiment of the present invention. Apparatus 700 comprises a base 788 and a trolley 792 that is preferably free to move relative to base 788. In the embodiment of FIG. 26, the motion of trolley 792 is guided by a first guide 794 and a second guide 796.

Apparatus 700 also comprises a balance mechanism 706 for providing a balancing force between trolley 792 and base 788. In the embodiment of FIG. 26, balance mechanism 706 includes a wheel 734 comprising a pulley member 740 and a cam member 742. In the embodiment of FIG. 26, a second cable 744 is shown extending between the pulley member 740 and trolley 792. Second cable 744 is attached to trolley 792 at an anchor 798. Anchor 798 is represented by a circle in FIG. 26.

Apparatus 700 also comprises a first cable 762. In the embodiment of FIG. 26, a first end 200 of a first cable 762 is connected to cam member 742 of wheel 734. In FIG. 26, first cable 762 is shown extending between cam member 742 and a pulley 755. Also in FIG. 26, first cable 762 is shown wrapping partially around pulley 755. A second end of first cable 762 may be fixed to base 788. Pulley 755 is pivotally supported by an axle 757 that is connected to a bracket 759. Bracket 759 is fixed to a top spring plate 773 of an energy source ES.

In the embodiment of FIG. 10, energy source ES comprises a plurality of extension springs 770. In this exemplary embodiment, the output of energy source ES may vary as a function of a deflection of the extension springs 770. Apparatus 700 of FIG. 10 also includes an adjustment mechanism ADJ that may be used to vary an output of energy source ES. With reference to FIG. 10, it will be appreciated that extension springs 770 extend between a bottom spring plate 772 and a top spring plate 773. Bottom spring plate 772 is coupled to a base 788 of apparatus 700 by an adjustment screw 790. The position of bottom spring plate 772 relative to base 788 can be adjusted by rotating adjustment screw 790. A force F applied to axle 757 by energy source ES is represented with an arrow in FIG. 26.

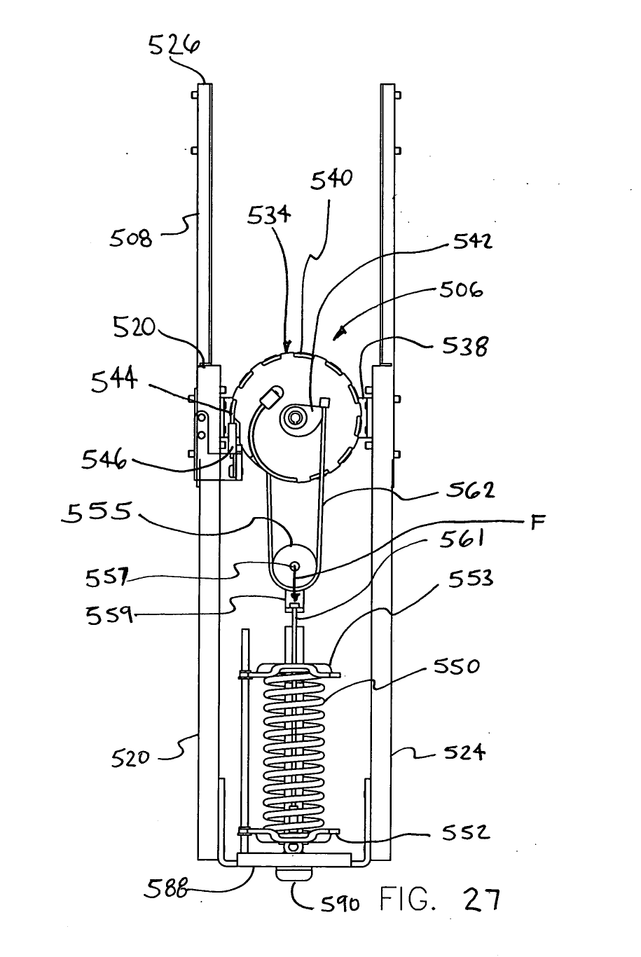

FIG. 27 is an elevation view of an apparatus 500 in accordance with an additional embodiment of the present invention. Apparatus 500 of FIG. 27 includes a balance mechanism 506 comprising a spring 550 that is disposed between a bottom spring plate 552 and a top spring plate 553. Top spring plate 553 is coupled to a base 588 of apparatus 500 by an adjustment screw 590. In the embodiment of FIG. 27, adjustment screw 590 threadingly engages top spring plate 553 such that the distance between top spring plate 553 and base 588 can be adjusted by rotating adjustment screw 590.

Base 588 of apparatus 500 is coupled to a first outer rail 520 and a second outer rail 524. A flange 538 of apparatus 500 is also coupled to first outer rail 520 and second outer rail 524. A wheel 534 of a balance mechanism 506 is pivotally supported by flange 538, first outer rail 520 and second outer rail 524. In the embodiment of FIG. 27, balance mechanism 506 is coupled between a first inner rail 508 and a first outer rail 520. Balance mechanism 506 may advantageously provide a balancing force between first inner rail 508 and first outer rail 520. In the embodiment of FIG. 27, the balancing force provided by balance mechanism 506 can be adjusted by rotating adjustment screw 590.

In the embodiment of FIG. 27, wheel 534 of balance mechanism comprises a cam member 542. In the embodiment of FIG. 27, the first end of a first cable 562 is connected to cam member 542. In FIG. 27, first cable 562 is shown extending between cam member 542 and a pulley 555. Also in FIG. 27, first cable 562 is shown wrapping partially around pulley 555. A second end of first cable 562 may be fixed to flange 538. Pulley 555 is pivotally supported by an axle 557 that is connected to a bracket 559. Bracket 559 is coupled to spring 550 by a third cable 561 and bottom spring plate 552. A force F applied to axle 557 by spring 550 is represented with an arrow in FIG. 27. In some useful embodiments of the present invention, cam member 542 is shaped and positioned so that a torque applied to wheel 534 by spring 550 is substantially constant while a force applied to wheel 534 by spring 550 varies. The force provided by spring 550 may vary, for example, as the deflection of spring 550 varies.

In the embodiment of FIG. 27, wheel 534 comprises a pulley member 540 that is coupled to first inner rail 508 of first slide 502 by a bracket 546 and a second cable 544. Accordingly, wheel 534 may be urged to rotate in a counter-clockwise direction 548 by moving distal end 526 of first inner rail 508 toward distal end 527 of first outer rail 520. In some useful embodiments of the present invention, second cable 544 applies a substantially constant balancing force to first inner rail 508.

Numerous characteristics and advantages of the invention covered by this document have been set forth in the foregoing description. It will be understood, however, that this disclosure is, in many respects, only illustrative. Changes may be made in details, particularly in matters of shape, size and ordering of steps without exceeding the scope of the invention. The invention's scope is, of course, defined in the language in which the appended claims are expressed.

1. An apparatus, comprising:
a first leg and a second leg disposed in sliding or rolling engagement with one another;
the first leg being fixed to a base;
a balancing mechanism disposed within a cavity defined by the base;
the balancing mechanism being capable of providing a balancing force between the second leg and the first leg.

2. The apparatus of claim 1, further comprising a first cable connecting the second leg to a wheel of the balancing mechanism.

3. The apparatus of claim 1, further comprising a second cable connecting a cam member of the wheel to an energy source for biasing the wheel to rotate in a first direction.

4. The apparatus of claim 3, wherein the cam member is shaped and positioned so that a torque applied to the wheel by the second cable is substantially constant while a force applied to the cam member by the second cable varies.

5. The apparatus of claim 3, wherein the cam member is shaped and positioned so that a torque applied to the wheel by the second cable varies in accordance with a predetermine force profile.

6. The apparatus of claim 3, wherein the cam member is shaped and positioned so that the second cable contacts the cam member at a first intersection disposed a first distance from the pivot axis when the wheel is disposed in a first orientation; and
the second cable contacts the cam member at a second intersection disposed a second distance from the pivot axis when the wheel is disposed in a second orientation.

7. The apparatus of claim 3, wherein the cam member is shaped so that the bias urging the wheel to rotate in the first direction is substantially constant or varied in a pre-determined manner as an output of a energy source changes.

8. The apparatus of claim 3, wherein an effective radius of the cam member varies as a function of the angular orientation of the wheel.

9. The apparatus of claim 3, wherein an effective radius of the cam member varies as a function of an output of an energy source.

10. The apparatus of claim 3, wherein the energy source comprises a spring

11. The apparatus of claim 10, wherein the spring is selected from the group consisting of torsion springs, extension springs, gas springs and compression springs.

12. The apparatus of claim 10, wherein an output of the energy source varies as a function of a deflection of the spring.

13. The apparatus of claim 10, further comprising an adjustment mechanism capable of changing a spring rate of the spring.

14. The apparatus of claim 13, wherein the adjustment system comprises a first spring plate coupled to a first end of a spring and a second spring plate coupled to a second of a spring.

15. The apparatus of claim 14, wherein the adjustment system a screw capable of moving one spring plate relative to the other spring plate.

16. The apparatus of claim 14, wherein the adjustment system comprises a screw capable of varying the position of one of the spring plates.

17. An apparatus, comprising:
a first leg and a second leg disposed in sliding or rolling engagement with one another;
the first leg being fixed to a base;
a wheel pivotally supported by the base;
the wheel comprising a pulley member and a cam member;
a second cable extending between the cam member of the wheel and a energy source so that the wheel is biased to rotate in a first direction;
a first cable extending between the pulley member and the second leg for providing a balancing force between the second leg and the first leg;

18. The apparatus of claim 17, wherein the cam member is shaped and positioned so that a torque applied to the wheel by the second cable is substantially constant while a force applied to the cam member by the second cable varies.

19. The apparatus of claim 17, wherein the cam member is shaped and positioned so that a torque applied to the wheel by the second cable varies in accordance with a predetermine force profile.

20. The apparatus of claim 17, wherein the cam member is shaped and positioned so that the second cable contacts the cam member at a first intersection disposed a first distance from the pivot axis when the wheel is disposed in a first orientation; and
the second cable contacts the cam member at a second intersection disposed a second distance from the pivot axis when the wheel is disposed in a second orientation.

21. The apparatus of claim 17, wherein the cam member is shaped so that the bias urging the wheel to rotate in the first direction is substantially constant or varied in a pre-determined manner as an output of a energy source changes.

22. The apparatus of claim 17, wherein an effective radius of the cam member varies as a function of the angular orientation of the wheel.

23. The apparatus of claim 17, wherein an effective radius of the cam member varies as a function of an output of an energy source.

24. The apparatus of claim 17, wherein the energy source comprises a spring

25. The apparatus of claim 24, wherein the spring is selected from the group consisting of torsion springs, extension springs and compression springs.

26. The apparatus of claim 24, wherein an output of the energy source varies as a function of a deflection of the spring.

27. The apparatus of claim 24, further comprising an adjustment mechanism capable of changing a spring rate of the spring.

28. The apparatus of claim 27, wherein the adjustment system comprises a first spring plate coupled to a first end of a spring and a second spring plate coupled to a second of a spring.

29. The apparatus of claim 28, wherein the adjustment system comprises a screw capable of moving one spring plate relative to the other spring plate.

30. The apparatus of claim 28, wherein the adjustment system comprises a screw capable of varying the position of one of the spring plates.

31. An apparatus, comprising:
a wheel pivotally supported by a first component;
the wheel comprising a pulley member and a cam member;
a first cable extending between the cam member of the wheel and a pulley that is pivotally supported by an axle;
an energy source applying a force to the axle so that the wheel is biased to rotate in a first direction;
a second cable extending between the pulley member and a second component;
the cam member being shaped so that a torque applied to the wheel by the second cable is substantially constant or varied in a pre-determined manner while a deflection of the energy source varies.

32. The apparatus of claim 31, wherein the pulley member defines a first cable path and the cam member defines a second cable path.

33. The apparatus of claim 31, wherein the first cable path has a first radius and the second cable path has a second radius.

34. The apparatus of claim 31, wherein the second radius of the second cable path varies as a function of an angular orientation of the wheel.

35. The apparatus of claim 31, wherein the second radius of the second cable path varies as a function of a deflection of the energy source.

36. The apparatus of claim 31, further including at least one guide for guiding relative motion between the second component and the first component.

37. The apparatus of claim 36, wherein the guide comprises a ball slide.

38. An apparatus, comprising:
a first bracket and a second bracket pivotally engaging one another so as to rotate about a pivot axis relative to one another;
the first bracket supporting a load such that the load creates a load moment about the pivot axis;
a cam coupled to the first bracket; and
a cable cooperating with the cam for providing a balancing moment about the pivot axis.

39. The apparatus of claim 38, wherein the cam member is shaped and positioned so that the balancing moment varies as a function of the load moment when the first bracket is pivoted about the pivot axis.

40. The apparatus of claim 39, wherein the cam member is shaped and positioned so that the balancing moment is substantially equal to the load moment as the first bracket is pivoted about the pivot axis.

41. The apparatus of claim 38, wherein the cam member is shaped and positioned so that the balancing moment is substantially equal to the load moment while a force applied to the cam member by the cable varies.

42. The apparatus of claim 38, wherein the cam member is shaped and positioned so that the balancing moment varies in accordance with a predetermine profile while a force applied to the cam member by the cable varies.

43. The apparatus of claim 38, wherein the cable connects the cam to an energy source for biasing the cam to rotate in a selected direction.

44. The apparatus of claim 43, wherein the energy source comprises a spring

45. The apparatus of claim 44, wherein the spring is selected from the group consisting of torsion springs, extension springs, gas springs and compression springs.

46. The apparatus of claim 44, wherein an output of the energy source varies as a function of a deflection of the spring.

47. The apparatus of claim 44, further comprising an adjustment mechanism capable of changing a spring rate of the spring.

48. The apparatus of claim 44, further comprising an adjustment mechanism capable of altering a pre-load on the spring.

49. The apparatus of claim 38, wherein an effective radius of the cam member varies as a function of the angular orientation of the first bracket.

50. The apparatus of claim 38, wherein:
the first bracket is pivotable between a first orientation and a second orientation;
a first spring force multiplied by a first effective cam radius being equal to a weight of the load multiplied by a first effective load arm when the first bracket assumes the first orientation; and
a second spring force multiplied by a second effective cam radius being equal to a weight of the load multiplied by a second effective load arm when the second bracket assumes the second orientation.

51. The apparatus of claim 38, wherein the balancing moment is substantially equal to a spring force multiplied by an effective radius of the cam.

52. The apparatus of claim 38, wherein the balancing moment varies as a function of the trigonometric sin function of a tilt angle of the apparatus.

53. The apparatus of claim 38, wherein the load moment is substantially equal to a weight of the load multiplied by an effective moment arm of the load.

54. The apparatus of claim 53, wherein the effective moment arm of the load is equal to a load radius multiplied by the trigonometric sin function of a tilt angle of first bracket.

55. The apparatus of claim 54, wherein the tilt angle is measured relative to a direction of gravitational pull.

56. The apparatus of claim 54, wherein the tilt angle defined by the direction of gravitational pull and a reference line extending through the pivot axis and a center of gravity of the load.

57. An apparatus, comprising:
a first bracket and a second bracket pivotally engaging one another so as to rotate about a pivot axis relative to one another;
a mounting plate pivotally coupled to the first mounting bracket by an axle;
a cam coupled to the second bracket;
a pin slidingly supported by the first bracket; and
a cable extending between the pin and the cam.

58. The apparatus of claim 57, wherein the pin is capable of assuming a first position in which relative rotation between the mounting plate and the first bracket is precluded and a second position in which the mounting plate and the first bracket may rotate relative to one another.

59. The apparatus of claim 58, further including a spring arranged to bias the pin toward the first position.

60. The apparatus of claim 59, wherein the cable and the cam cooperate to urge the pin toward the second position when the first bracket and the second bracket are pivoted relative to one anther.
